(19) United States
(12) Patent Application Publication
(10) Pub. No.: US 2026/0322432 A1
(43) Pub. Date: Oct. 15, 2026

(54) FULL-DUPLEX REFLECTOR-ASSISTED MONO-STATIC SENSING

(71) Applicant: Fraunhofer-Gesellschaft zur Förderung der angewandten Forschung e.V., München (DE)

(72) Inventors: Ehsan TOHIDI, Berlin (DE); Ramez ASKAR, Berlin (DE); Zoran UTKOVSKI, Berlin (DE); Slawomir STANCZAK, Berlin (DE)

(21) Appl. No.: 19/688,798

(22) Filed: May 27, 2026

Related U.S. Application Data
(63) Continuation of application No. PCT/EP2023/083964, filed on Dec. 1, 2023.

(51) Int. Cl. H04B 7/0413; H04B 7/0408

(52) U.S. Cl. CPC H04B 7/0413; H04B 7/0408

(57) ABSTRACT

A network entity for a wireless communication network has a plurality of antennas or an antenna array. The network entity controls the plurality of antennas or the antenna array to form a plurality of beams and to concurrently transmit and receive on the plurality of beams. The network entity communicates with one or more second network entities. The network entity senses a surrounding of the network entity using a reflection of a radio signal. The network entity transmits the radio signal on the first beam which is directed into a first direction. The network entity directs the second beam into a second direction pointing towards a reflector receiving from the surrounding the reflection of the radio signal and directing the reflection of the radio signal towards the network entity.

### CROSS-REFERENCE TO RELATED APPLICATIONS

This application is a continuation of copending International Application No. PCT/EP 2023/083964, filed Dec. 1, 2023, which is incorporated herein by reference in its entirety.

The present invention relates to the field of wireless communication systems or networks, more specifically to an integrated sensing and communication in such systems or networks. Embodiments of the present invention concern a network entity integrating sensing and communication and using a full-duplex operation for supporting mono-static sensing so that the network entity performs both a transmission of a radio signal and a reception of a reflected signal.

### BACKGROUND OF THE INVENTION

FIG. 1 is a schematic representation of an example of a terrestrial wireless network 100 including, as is shown in FIG. 1A, the core network, CN, 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. The BS may also comprise of integrated access and backhaul, IAB, nodes, e.g., an IAB Donor and/or IAB Node, consisting of a central unit, CU, as well as of a distributed unit, DU, and/or containing IAB-MTs including IAB mobile termination, MT. The term base station may refer to an access point, AP, in any of the WiFi standards, e.g., belonging to the IEEE 802.11-familiy. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-familiy.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 6G or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or 5G-Advanced or NR, New Radio, or a possible future 6G radio system.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations or a WiFi AP.

As wireless communication networks evolve, like the 3GPP network described above with reference to FIG. 1 or the Wi-Fi system, new services or applications may be implemented, like sensing services or applications. For example, wireless signal sensing and communication may be integrated in a single system, also referred to as Integrated Sensing And Communication, ISAC, or Integrated Communication And Sensing, ICAS. The entire communications network may be considered a sensor, and the radio signals transmitted/received by the network elements or entities and the radio wave transmissions, reflections, and scattering may be used to sense the physical world. For example, autonomous vehicles and drones may be required to continuously image their spatial environment and exchange information with each other. A project called 6G-ICAS4Mobility aims to achieve a closer coupling of sensor-based environment detection and communication in order to improve the safety of road users and traffic efficiency. Another project called “Perceptive communication networks with integrated sensor technology for 6th generation mobile communications (KOMSENS-6G)” focuses on integrating sensor technology into 6G communication systems for enabling future applications in Industry 4.0 or autonomous mobility.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements for integrating sensing and communication in a wireless communication system or network.

### SUMMARY

According to an embodiment, a network entity for a wireless communication network may have: a plurality of antennas or an antenna array including a plurality of antenna elements, wherein the network entity is configured to control the plurality of antennas or the antenna array to form a plurality of beams and to concurrently transmit and receive on the plurality of beams, the plurality of beams including at least a first beam and a second beam, wherein the network entity is a first network entity configured to communicate with one or more second network entities of the wireless communication network, and wherein the network entity is configured to sense a surrounding of the network entity using a reflection of a radio signal, wherein the network entity is configured to transmit the radio signal on the first beam which is directed into a first direction, wherein the network entity is configured to direct the second beam into a second direction, the second direction pointing towards a reflector, the reflector receiving from the surrounding the reflection of the radio signal and directing the reflection of the radio signal towards the network entity, and wherein the first direction into which the first beam is directed is different from the second direction into which the second beam is directed.

According to another embodiment, a wireless communication network may have: one or more network entities, the network entity having: a plurality of antennas or an antenna array including a plurality of antenna elements, wherein the network entity is configured to control the plurality of antennas or the antenna array to form a plurality of beams and to concurrently transmit and receive on the plurality of beams, the plurality of beams including at least a first beam and a second beam, wherein the network entity is a first network entity configured to communicate with one or more second network entities of the wireless communication network, and wherein the network entity is configured to sense a surrounding of the network entity using a reflection of a radio signal, wherein the network entity is configured to transmit the radio signal on the first beam which is directed into a first direction, wherein the network entity is configured to direct the second beam into a second direction, the second direction pointing towards a reflector, the reflector receiving from the surrounding the reflection of the radio signal and directing the reflection of the radio signal towards the network entity, and wherein the first direction into which the first beam is directed is different from the second direction into which the second beam is directed, and one or more reflectors, the reflector receiving from one or more objects a reflection of a radio signal of the network entity and directing the reflection of the radio signal towards the network entity.

According to another embodiment, a method for sensing and communicating in a wireless communication network may have the steps of: controlling a plurality of antennas or an antenna array of a first network entity to form a plurality of beams and to concurrently transmit and receive on the plurality of beams, the plurality of beams including at least a first beam and a second beam, communicating, by the first network entity, with one or more second network entities of the wireless communication network, and sensing, by the first network entity, a surrounding of the first network entity using a reflection of a radio signal, wherein the sensing includes: transmitting the radio signal on the first beam which is directed into a first direction, and directing the second beam into a second direction, the second direction pointing towards a reflector, the reflector receiving from the surrounding the reflection of the radio signal and directing the reflection of the radio signal towards the first network entity, wherein the first direction into which the first beam is directed is different from the second direction into which the second beam is directed.

### BRIEF DESCRIPTION OF THE DRAWINGS

Embodiments of the present invention will be detailed subsequently referring to the appended drawings, in which:

FIG. 1A-B illustrate a wireless communication network, wherein FIG. 1A is a schematic representation of an example of a terrestrial wireless network, and FIG. 1B is a schematic representation of an example of a radio access network, RAN;

FIG. 2 is a schematic representation of a wireless communication system including a transmitter, like a base station, and one or more receivers, like user devices, UEs, implementing embodiments of the present invention;

FIG. 3 illustrates a network entity in accordance with embodiments of the present invention using a non-configurable reflector;

FIG. 4 illustrates a network entity in accordance with further embodiments of the present invention using a configurable reflector;

FIG. 5 is a flow diagram illustrating a base station assisted operation of an ISAC UE according to the embodiment of FIG. 4;

FIG. 6 illustrates a vehicle-to-vehicle communication in accordance with embodiments of the present invention;

FIG. 7 illustrates an implementation of ISAC in a campus network in accordance with further embodiments of the present invention;

FIG. 8 illustrates an embodiment of the present invention being implemented in a base station;

FIG. 9 illustrates an RIS sweeping approach in accordance with embodiments of the present invention;

FIG. 10 illustrates an embodiment of a beam sweeping by the base station in accordance with embodiments of the present invention;

FIG. 11 illustrates a base station in accordance with embodiments of the present invention; and

FIG. 12 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

For implementing integrated sensing and communication in a wireless communication network, the same communication infrastructure is used to provide both for the communication and for the sensing. Sensing may refer to a radio frequency, RF, sensing performing radar-like functionality, i.e., the ability to detect the presence, movement, and other characteristics or of objects/living within the wireless network coverage. Sensing may also refer to the detection of general characteristics of the environment, i.e., environmental mapping, as well as environmental sensing, e.g., a detection of local weather conditions, traffic monitoring, and the like. For example, 3GPP TR 22.837 V 19.1.0 (2023-09) describes use cases and requirements for the enhancement of a 5G system to provide sensing services addressing different target verticals/applications, e.g. autonomous/assisted driving, V 2X, UAVs, 3D map reconstruction, smart city, smart home, factories, healthcare, maritime sector. The sensing may use data derived from 3GPP radio signals impacted, e.g., reflected, refracted, diffracted, by an object or environment of interest for sensing purposes. The sensing may obtain information about characteristics of the environment and/or objects/living beings within the environment, e.g., shape, size, orientation, speed, location, distances or relative motion between objects/living beings, using RF signals.

Integrated sensing and communication may be implemented in a mono-static fashion, in which a transmitter and receiver of the sensing signals are co-located, or bi-static fashion, in which a transmitter and receiver of the sensing signals are separated by a certain distance. For implementing integrated sensing and communication in a mono-static fashion, the network entity, like a user device or user equipment, UE, is both the transmitter and the receiver of the sensing signal. In other words, the transmission of the sensing signal and reception of the reflected signal are performed by the same node.

### Other Than Conventional Mono-static Radar Systems, Which Do Not Require the

transmitter and the receiver to be active simultaneously, in a wireless communication system, for supporting mono-static sensing applications, the conventional half-duplex operation performing transmission and reception at different times or frequencies is not suited. For example, an expected sensing range for a mono-static sensing application may be smaller than 1 km, which means that the round trip time, RTT, of the reflected signal is in the order of several μs or less. In comparison, typical data transmissions use much larger time scales, e.g. in the order of tens of μsin a typical 5G OFDM-based air interface. Thus, during the time the network entity is transmitting a communication signal to another network entity, reflections of the communication signal or of a sensing signal are already received at the network entity so that, in a mono-static scenario, the network entity or communication node needs to be capable of transmitting and receiving almost instantly, i.e., the network entity needs to support some form of full-duplex operation. However, a full-duplex operation requires a high level of self-interference cancellation, SIC, for achieving an acceptable performance.

SIC techniques may be categorized according to where the self-interference signal's cancellation occurs. Two of the self-interference cancellation, SIC, categories have drawn much attention in the published literature in the last decade and a half, namely:
RF domain self-interference cancellation, SIC, and
digital domain self-interference cancellation, SIC. The analog domain cancellation, though, where the self-interference signal is canceled at the analog domain after the down-conversion and before the ADC, has not been pursued in the literature as it does not offer any competitive advantages compared to the RF domain cancellation. The analog domain cancellation is considered the SIC in which the SIC occurs to the analog baseband signal, unlike the RF domain cancellation, where the cancellation occurs to the up-converted signal in the analog RF domain.

Even though all these techniques share a common objective of canceling the self-interference signal, they practically follow different approaches. For example, the radio frequency, RF, domain cancellation techniques have been implemented either passively by attenuating the self-interference, referred to also as attenuation approaches, or actively by adding a SIC signal to the RF reception signal, referred to also as signal-injection approaches.

### Self-interference Cancellation in RF Domain

### Attenuation Approaches

Such SIC approaches were investigated in almost all the literature since they offer a first-stage self-interference suppression method and reduce the interference requirement for the up-following cancellation stages. At the beginning of the FD research, works in references [1] and [5] proposed a SIC technique based on a conditional arrangement of antennas. The cancellation technique requires two transmit antennas spaced apart from the receiver antenna by distances d and d+λ/2. In that way, the two transmit antennas produce a null in their antenna pattern at the receiver antenna location. As experiments showed, this cancellation technique works well only for narrowband systems; around 30 dB of self-interference suppression at the center frequency is achieved.

Further work in references [4]; [29]; [35]; [34] has attempted to overcome the aforementioned drawback of the SIC technique and additionally reduce the number of the required antennas. These approaches also include the utilization of the directivity of the antennas in combination with some other techniques such as the physical separation of the antennas, different polarizations, and additional RF absorbing materials, see references [3]; [23]; [31]; [6]. The passive cancellation approach achieves its highest cancellation result—more than 65 dB of suppression was measured over ≈165 MHz—in conditions where the transmit and receive antennas are oriented in two opposite directions; which is suitable for relay station scenarios in references [17]; [32]. Another advancement was achieved in terms of broadening the SIC bandwidth: The researchers in reference [8] have developed an antenna structure. The structure comprises eight transmit monopole antennas that are placed equidistantly in a ring shape and a receive monopole antenna that is mounted at an elevated position in the center of the ring structure. Unlike the known λ/2λ two-antennas-relative-distance approach, a progressive phase shift of 180° was applied to each opposite pair of transmit-monopole antennas by means of an RF 180°-hybrid (analog beamformer circuitry). An overall self-interference suppression greater than 55 dB is experimentally reported within this particular implementation, over a frequency band between 2.4 GHz and 2.5 GHz.

Another well-known element to connect one antenna with the transmit and receive chain is the 3-port RF-circulator. It is used to attenuate the Tx-to-Rx leakage (a first-tap component of the self-interference radio channel) by benefiting from the anisotropic property of the RF-circulator, see reference [22]. The RF-circulator element was utilized as a part of the entire self-interference mechanism, which has achieved 10 dB to 15 dB of passive self-interference suppression, see reference [15].

All these passive techniques have shown high SIC results for the primary (first-tap) self-interference component; however, they were vulnerable against reflections and backscattering from the wireless channel, causing a frequency-selective behavior of the self-interference signal. The main drawback of the RF-circulator approach is the reflection at the antenna port due to impedance mismatch. In practical systems, this self-interference component dominates the circulator leakage, limiting its suppression performance to the reflection factor of the attached antenna.

### Signal-injection Approaches

In the area of RF-injection techniques, the authors in reference [4] have introduced the RF Balun (balanced-to-unbalanced transformer) to produce a negative version of the self-interference signal—as used historically for echo cancellation in telephones. This concept was further enhanced by including active circuitry (QHx220 chip), adapting attenuation and delay of the (negative) cancellation signal. For a bandwidth of 40 MHz, over 45 dB SIC was experimentally reached by means of the Balun setup, whereas the loss in link-budget is around 6 dB. However, this approach has a severe practical limitation by the additional nonlinearities that the active circuitry introduces to the SIC signal. In contrast to the Balun, the authors in references [29]; [35]; [34] used a 180°-hybrid RF transformer to generate the inverted version of the self-interference signal. The reflecting factor of the antenna is matched by employing a digitally-controlled impedance-matching circuit. The RF-hybrid junction and a tuned matching circuit suppress the self-interference. However, this approach also compromises the link budget by 6 dB, similar to the Balun. In summary, both approaches are usually limited to the cancellation of the main (first tap) self-interference component. One of the most prominent approaches under the RF-injection category is the auxiliary-transmitter-based one references [2]; [6]; [7]; [34]; [19]; [20]; [30]; [36]; [43]. This approach requires an additional transmission chain alongside the ordinary one. This additional chain is dedicated to replicating an inverted self-interference signal and injecting it at the receiver RF front-end to cancel the self-interference. Generating the SIC signal starts from the IQ samples at the digital domain. The pre-processing to the digital domain enables the implementation of several sophisticated digital-signal-processing (DSP) algorithms in which the multi-path self-interference wireless channel is included in the waveform of the SIC signal. Despite the flexibility that the active cancellation technique has established by considering the whole self-interference wireless channel, this technique suffers from some limitations due to hardware impairments. Transceiver hardware impairment such as the IQ imbalances, see reference [28], nonlinear behavior of the components, see references [11]; [27]; [13], the local oscillator phase noise, see references [10]; [18]; [12], needs to be taken into account as limiting factor for SIC performance. Most of these impairments have been studied extensively in the literature. As a matter of fact, the non-deterministic nature of these impairments, for example, the phase noise, has been characterized as the bottleneck in the active cancellation mechanism. For example, the phase noise of the local oscillator limits the performance of the active cancellation mechanism, see references [10]; [18], even though the same local oscillator is used for both transmit chains-the ordinary transmitter and the auxiliary one. This is because the self-interference signal travels through the ordinary transmission chain followed by a multi-path radio channel and accordingly subjects to different delay values as compared to the SIC signal that only goes through the auxiliary transmission chain. The transmitter-generated noise is another limitation of this approach as it is generated independently at the ordinary and auxiliary transmitter chain, see reference [16].

Another advanced approach of the RF-injection technique focuses on the direct generation of a correlated cancellation signal in order to overcome the shortcomings of the auxiliary transmitter approach. This cancellation technique is based on a printed circuit board (PCB) with multiple routes, having different lengths in order to provide several delays. These multiple routes (taped delay lines) are supported with digitally-controlled adjustable attenuators. The entire design is used to imitate the circulator leakage and the antenna impedance-mismatch reflection, see references [15]; [14]. However, the rest of the multi-path self-interference wireless channel cannot be compensated within this setup. Another drawback of this approach is the off-coupling of the SIC signal, which would compromise a significant portion of the transmit power if it did not adequately split. The approach in terms of canceling the self-interference has reached a tremendous value, around 72 dB was measured in references [15] at the RF, including the circulator suppression; however, it serves only to prove the concept. A real-world wireless transceiver that follows this approach needs to deal with implementing the physical delay routes as progressive delay lines, which are extremely difficult to realize in practice. The extension of this approach to multiple-antennas configurations complicates the RF structure to some certain degree, as it was shown in reference [21], although simplifying the RF structure was one of the major goals in the previously cited article. Other research groups adopted the principle of the cancellation method. A team at Riverside university has proposed to rearrange the delay routes on the PCB structure in a cluster shape, enabling those complex channel coefficients could be applied to the SIC signal at the RF domain, see references [24]; [25]; [33]. The researchers have claimed that such clustered arrangement for the adjustable delay taps has an advantage over the uniform one, such as in reference [15], in decreasing the dependency on the carrier frequency. However, the researcher never investigates the clustered structure's feasibility in canceling the transmitter-generated noise. Another research group has adopted the same cancellation principle and developed an RF cancellation circuit that includes variable attenuators and phase shifters in addition to the fixed-delay taps, see references [9]; [26]. The four-tap-delay structure has achieved a minimum of 30 dB of SIC over 30 MHz frequency band experimentally.

### Decoupling Approaches

The decoupling-network technique targets the antenna-mutual-coupling caused self-interference channel segment. In a nutshell, the technique relies on an RF lossless decoupling network, which interconnects the transceiver's chains to the antenna elements, to compensate for the mutual coupling among the antennas. The values of the network's reactive elements, which are the building blocks of the lossless network, can be computed to cancel the self-interference at the local receivers for the targeted frequency. Thus, the technique provides a SIC method at the RF domain, which does not waste energy for cancellation purposes. Moreover, the technique can implicitly assure optimized power delivery among the antenna array elements and the transceiver front-ends, see references [39]; [40]; [47]; [44].

### Self-Interference Cancellation in Digital Domain

Many algorithms and signal models have been explored in the published literature. The major stream has been considered a linear model due to its simplicity. However, the linear model suppresses only the linear part of the residual self-interference signal in the digital domain, which is not sufficient in practical systems, see reference [15]. Widely-linear models were also considered in some of the state of the art in order to increase the digital suppression amount, see reference [28]. Even nonlinear models were exploited to improve the performance of the residual self-interference suppression at the digital domain, see references [15]; [11]; [27]; [13]; [37]; [38]; [42]; [41]. Recently, machine learning techniques relying on kernel-based adaptive filter, such as adaptive projected subgradient method (APSM), are also used for digital SIC purposes, see references [46]; [45].

If self-interference is not handled properly, it may cause receiver saturation, e.g., by saturating a low-noise amplifier, LNA, or an analog-to-digital converter, ADC.

The present invention addresses the above described self-interference issue at a network entity by improving an angular separation between a signal transmitted by a network entity and a reflection of the signal received at the network entity. This is achieved by directing the reflected signal via a reflector to the network entity such that the network entity receives the reflected signal from a direction which is sufficiently different from a direction into which the signal is transmitted. In other words, an angular separation between the transmitted and the received signals is provided such that a self-interference at the network entity does not exceed a certain threshold.

The present invention is based on the finding that RF sensing may impose reduced self-interference-cancellation, SIC, requirements compared to the full-duplex operation in the context of a communication duplexing scheme. The potential to reduce the SIC requirements stems from the possibility of exploiting a spatial isolation between transmit and receive directions. When employing multiple antennas, a certain level of spatial isolation can be achieved by employing a spatial angle-of-arrival, AoA, difference between the transmitted and the reflected, i.e. received, signal. In accordance with the inventive approach, the AoA difference is implemented by employing a reflector, e.g., an intelligent reflecting surface, IRS, thereby decreasing or avoiding self-interference in a mono-static ISAC scenario. More specifically, by an appropriate receive beamforming at the network entity so that the receive beam is directed to the reflector, the reflector in effect provides a reflected signal path that is subject to smaller self-interference. In accordance with embodiments, when using an IRS as the reflector, the IRS elements may be intelligently adjusted to support creating the reflected signal path with reduced self-interference. The reason for the reduced self-interference is the better angular separation between the transmitted and the received signal reflected by the reflector. As a consequence, the supported sensing range may be increased and/or the self-interference, SI, suppression requirements on the hardware may be reduced. In other words, the present invention addresses the self-interference problem in full duplex operation of an ISAC network entity by leveraging a reflector, e.g., an intelligent reflecting surface, IRS, to provide a spatial separation of a transmitted and a received, i.e. reflected, signal in a mono-static sensing setting. By strategically deploying a reflector in the system, the self-interference may be mitigated efficiently, thereby enabling simultaneous sensing and communication operations.

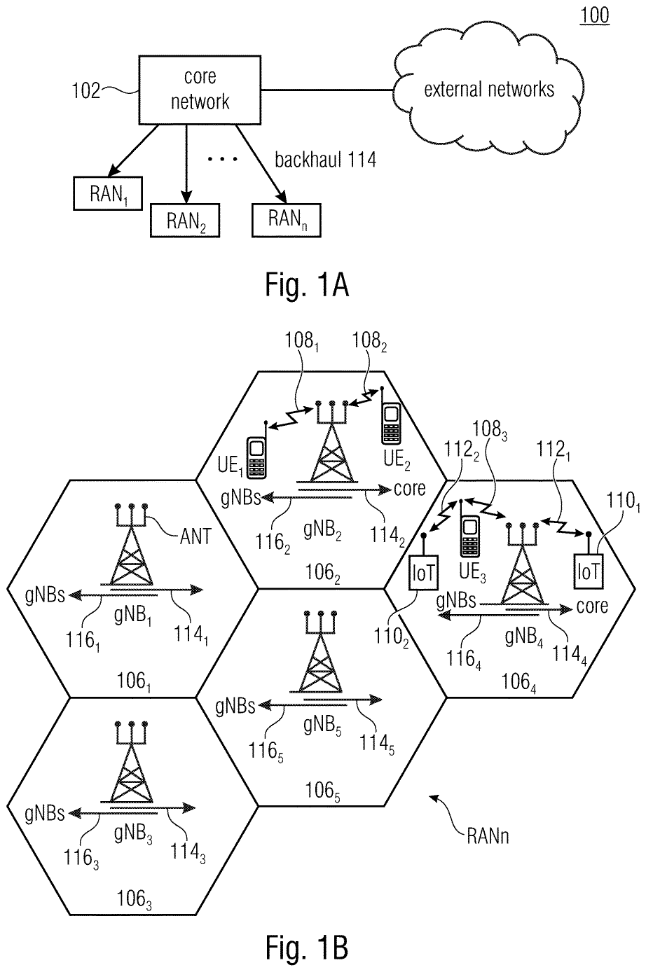

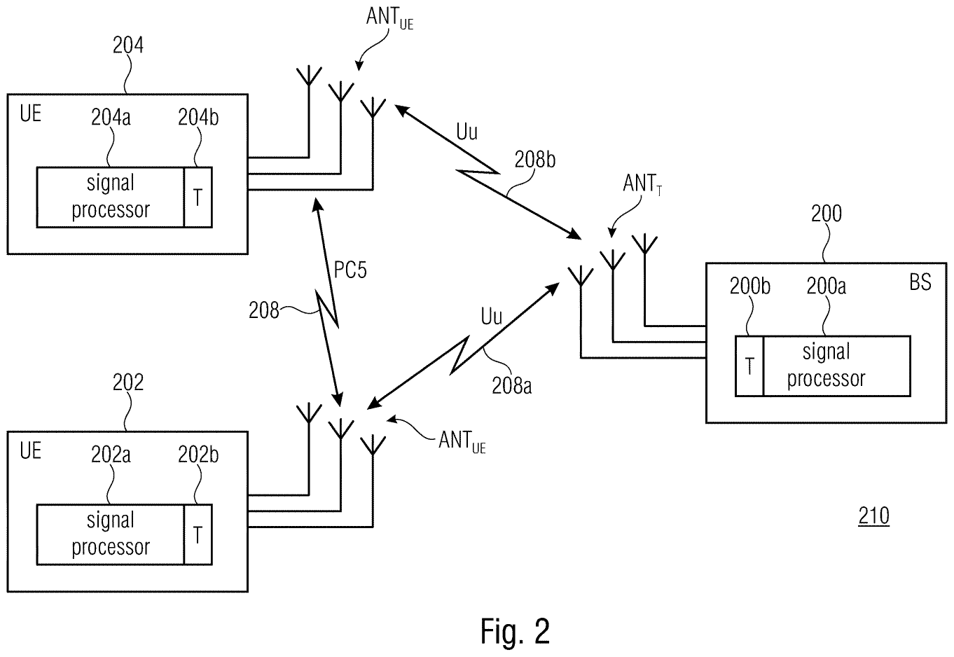

Embodiments of the present invention may be implemented in a wireless communication system as depicted in FIG. 1 including base stations and users, like mobile terminals or IoT devices. FIG. 2 is a schematic representation of a wireless communication system 210 including a transmitter 200, like a base station, and one or more receivers 202, 204, like user devices, UEs. The transmitter 200 and the receivers 202, 204 may communicate via one or more wireless communication links or channels 206a, 206b, 208, like a radio link. The transmitter 200 may include one or more antennas ANTT or an antenna array having a plurality of antenna elements, a signal processor 200a and a transceiver 200b, coupled with each other. The receivers 202, 204 include one or more antennas ANTUE or an antenna array having a plurality of antennas, a signal processor 202a, 204a, and a transceiver 202b, 204b coupled with each other. The base station 200 and the UEs 202, 204 may communicate via respective first wireless communication links 206a and 206b, like a radio link using the Uu interface, while the UEs 202, 204 may communicate with each other via a second wireless communication link 208, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 2, the one or more UEs 202, 204 of FIG. 2, and the base station 200 of FIG. 2 may operate in accordance with the inventive teachings described herein.

### Network Entity Preforming Communication and Sensing

The present invention provides a network entity for a wireless communication network, the network entity comprising:
a plurality of antennas or an antenna array including a plurality of antenna elements,
wherein the network entity is configured to control the plurality of antennas or the antenna array to form a plurality of beams and to concurrently transmit and receive on the plurality of beams, the plurality of beams including at least a first beam and a second beam,
wherein the network entity is a first network entity configured to communicate with one or more second network entities of the wireless communication network, and
wherein the network entity is configured to sense a surrounding of the network entity using a reflection of a radio signal,
wherein the network entity is configured to transmit the radio signal on the first beam which is directed into a first direction,
wherein the network entity is configured to direct the second beam into a second direction, the second direction pointing towards a reflector, the reflector receiving from the surrounding the reflection of the radio signal and directing the reflection of the radio signal towards the network entity, and
wherein the first direction into which the first beam is directed is different from the second direction into which the second beam is directed.

In accordance with embodiments, the radio signal comprises one or more communication specific signals and/or one or more sensing specific signals

In accordance with embodiments, the communication specific signals are associated with a communication between the network entity, and the sensing specific signals are not associated with a communication between the network entity but are used only for sensing the surrounding of the network entity.

In accordance with embodiments, the one or more communication specific signals comprises on or more of the following:
one or more pilot signals, like Frank-Zadoff-Chu, FZC, sequences or Gold sequences,
one or more reference signals, like a Synchronization Signal Block, SSB, a Phase-tracking reference signal PTRS, a Channel state information reference signal CSI-RS, or a Positioning Reference Signal, PRS,
one or more data signals, like payload or control data for the second network entity.

In accordance with embodiments, the one or more sensing specific signals comprises on or more of the following:
one or more pilot signals, like Frank-Zadoff-Chu, FZC, sequences or Gold sequences,
one or more reference signals, like a Synchronization Signal Block, SSB, a Phase-tracking reference signal PTRS, a Channel state information reference signal CSI-RS, or a Positioning Reference Signal, PRS,
one or more data signals, like payload or control data for the second network entity.
linear frequency modulation, LFM, signals,
non-linear frequency modulation, NLFM, signals.

In accordance with embodiments, the network entity is configured to set the first direction into which the first beam is directed and the second direction into which the second beam is directed such that a self-interference at the network entity does not exceed a certain threshold,

In accordance with embodiments,
for sensing the surrounding of the network entity at a first distance from the network entity, the certain threshold is a first threshold causing the network entity to set the first and second beams such that the first and second directions are spatially separated by a first amount, like a first angle,
for sensing the surrounding of the network entity at a second distance from the network entity, the certain threshold is a second threshold causing the network entity to set the first and second beams such that that the first and second directions are spatially separated by a second amount, like a second angle, and
wherein
the first threshold is higher than the second threshold,
the first distance is smaller than the second distance,
the first amount is smaller than the second amount.

In accordance with embodiments, the network entity is configured to sense the surrounding of the network entity using the reflection of the radio signal received on the second beam, or
wherein the network entity is configured to sense the surrounding of the network entity using the reflection of the radio signal received on the second beam and a reflection of the radio signal received on the first beam.

In accordance with embodiments, sensing the surrounding using the reflection of the radio signal comprises one or more of the following:
detecting one or more objects or living beings within the surrounding,
obtaining information about characteristics of the surrounding and/or one or more objects or living beings within the surrounding.

In accordance with embodiments, the characteristics of the one or more objects or living beings within the surrounding comprises one or more of the following:
a shape of an object/living being,
a size of an object/living being,
an orientation of an object/living being,
a speed of an object/living being,
a location of an object/living being, e.g., determining a position of an object/living being relative to the network entity or in absolute coordinates
a distance between an object/living being and the network entity,
a relative motion between objects/living beings,
a condition of an object/living, e.g., for determining to what degree a sensed condition corresponds to an expected condition of an object/living, like a human motion rate accuracy describing a closeness of a measured value of a human body movement frequency caused by parts of the e. human body to the true value of the human body movement frequency,
an image of an object/living being, such as an object material type,
a mapping of the one or more objects/living beings, e.g., for an environmental mapping.

In accordance with embodiments, the characteristics of the surrounding comprises one or more of the following:
a weather condition in the surrounding, e.g., a precipitation, like rain or snow fall, in the surrounding,
a geographical nature of the surrounding, like a slope, vegetation.

In accordance with embodiments, the one or more objects/living beings sensed by the network entity comprise one or more of the following:
the second network entity of the wireless communication network with which the network entity communicates,
a third network entity of the wireless communication network with which the network entity does not communicate,
an obstacle or a person in the surrounding of the network entity, e.g.,
   an obstacle or a person in a trajectory of the network entity, or
   an obstacle or a person blocking a communication link with the second network.

In accordance with embodiments, the network entity is configured to form the second beam using information about a location of the reflector relative to the network entity, and wherein the network entity is
preconfigured with a position of the reflector in the wireless communication network or with an angle at which the network entity is positioned relative to the reflector, e.g., during an initial access of the network entity to the wireless communication network, and/or
configured to receive from wireless communication network information about the location of the reflector relative to the network entity or about an angle at which the network entity is positioned relative to the reflector.

In accordance with embodiments, the network entity is configured to move, and wherein, when the network entity is moving, the network entity is configured to update the second direction such that the second beam keeps pointing towards the reflector.

In accordance with embodiments, the network entity is configured to update the second direction using one or more of the following:
the preconfigured position of the reflector in the wireless communication network,
the preconfigured angle at which the network entity is positioned relative to the reflector,
updated information about the location of the reflector relative to the network entity or about the angle at which the network entity is positioned relative to the reflector.

In accordance with embodiments, the network entity is configured to receive the information and/or the updated information from one or more of the following:
a control unit associated with the reflector,
a further network entity, e.g., via a configuration message from a base station,
the reflector.

In accordance with embodiments, the network entity is configured to form the second beam using a search mechanism allowing the network entity to select the second beam from a codebook of available beams or from a lookup table that stores historical information.

In accordance with embodiments, the reflector comprises
a non-configurable reflector, or,
a configurable reflector controllable to receive from and/or transmit to a desired direction, like a reconfigurable intelligent surface, RIS, or an intelligent reflecting surface, IRS, or
a relay device, e.g., an amplify and forward relay node.

In accordance with embodiments, the active reflector comprises configurable elements for directing a signal into a desired direction, and wherein the network entity is configured to cause a configuration of the active reflector such that the reflection of the radio signal is directed towards the network entity,

In accordance with embodiments, the network entity is configured to
request a further network entity of the wireless communication network to cause the configuration of the active reflector, e.g., a base station or a control unit of the active reflector, or
request the active reflector to cause the configuration of the active reflector, e.g., by sending a configuration message directly to the active reflector.

In accordance with embodiments, the network entity is configured to sweep the first and/or second beams so as to perform the sensing in two or more directions

In accordance with embodiments,
the network entity, e.g., a user device, UE, is served by a third network entity, like a base station, BS, of the wireless communication network, and
the network entity is configured to
   send a sensing request to the third network entity,
   receive from the third network entity a message including the information about the location of the reflector,
   form the second beam directed toward the reflector using the information included in the message received from the third network entity.

### Network Entity Serving a Further Network Entity Which Preforms Communication and Sensing

The present invention provides a network entity for a wireless communication network, the network entity comprising:
one or more antennas or an antenna array including one or more antenna elements,
wherein the network entity is a first network entity configured to serve one or more second network entities of the wireless communication network, the second network entity being configured to communicate with one or more third network entities of the wireless communication network, and to sense a surrounding of the second network entity using a reflection of a radio signal from the surrounding, and
wherein the network entity is configured to
   receive a sensing request from the second network entity, and
   send to the second network entity information about a location of a reflector of the wireless communication network relative to the second network entity, e.g., in absolute of relative coordinates, or about an angle at which the second network entity is positioned relative to the reflector, the reflector receiving from the surrounding the reflection of the radio signal and directing the reflection of the radio signal towards the second network entity.

In accordance with embodiments, responsive to a change of a position of the second network entity, e.g., when the second entity is a moving entity, the network entity is configured to send updated information about the location of the reflector relative to the second network entity or about the angle at which the network entity is positioned relative to the reflector.

In accordance with embodiments, the network entity is configured to
identify one or more reflectors of the wireless communication network available for cooperating with the second network entity, and
configure the one or more reflectors such that the reflector collects the reflection of the radio signal from the surrounding and directs the reflection of the radio signal to the second network entity.

In accordance with embodiments, responsive to a change of a position of the second network entity, e.g., when the second entity is a moving entity, the network entity is configured to control the reflector such that a direction into which the reflection of the radio signal to the second network entity is directed by the reflector is adjusted to keep pointing to the second network entity.

In accordance with embodiments, the network entity is configured to adjust the direction
continuously while the second network entity is moving, e.g., when determining that a position of the second network entity changed by a predefined amount, or
periodically, e.g., based on the maximum predefined speed of the second network entity and a known beamwidth, or
at predefined time intervals, e.g., since the environment or distribution of second network entities may be different at certain times.

In accordance with embodiments, the network entity comprises a base station or a user device, UE, of the wireless communication network,
wherein the base station comprises one of the following: a moving or stationary base station, or a macro cell base station, or small cell base station, or a central unit of a base station, or a distributed unit of a base station, or an Integrated Access and Backhaul, IAB, node, or a road side unit, RSU, or a WiFi access point, AP, or a relay or a remote radio head,
wherein the user device, UE, comprises one of the following: a power-limited UE, or a hand-held UE, like a UE used by a pedestrian also referred to as a Vulnerable Road User, VRU, or a Pedestrian UE, P-UE, or an on-body or hand-held UE used by public safety personnel and first responders, also referred to as Public safety UE, PS-UE, or an IoT, like a narrowband IoT, NB-IoT, device, a cellular IoT-device, an industrial IoT-device, an IIoT-device, or an ambient IoT-device, e.g., a sensor, an actuator or a UE provided in a campus network to carry out repetitive tasks and requiring input from a gateway node at periodic intervals, or a mobile terminal, or a stationary terminal, or a vehicular UE, or a vehicular group leader UE, GL-UE, or a scheduling UE, S-UE, a NTN UE, or a WiFi device or WiFi station, STA, or a robot, or a ground based vehicle, or an aerial vehicle, or a drone, or a building, or any transmission/reception point, TRP, enabling an item or a device to communicate using the wireless communication network, the item or device being provided with network connectivity to communicate using the wireless communication network, or any other item or device provided with network connectivity enabling the item/device to communicate using the wireless communication network, e.g., a sensor or actuator, or any other item or device provided with network connectivity enabling the item/device to communicate using a sidelink of the wireless communication network, e.g., a sensor or actuator, or any sidelink capable network entity.

### Network

The present invention provides a wireless communication network, comprising
one or more inventive network entities network entities which preforms communication and sensing, and
one or more reflectors, the reflector receiving from one or more objects a reflection of a radio signal of the network entity and directing the reflection of the radio signal towards the network entity. In accordance with embodiments, the wireless communication network comprises one or more further inventive network entities serving the inventive network entity which preforms communication and sensing.

### Methods

The present invention provides a method for sensing and communicating in a wireless communication network, the method comprising:
controlling a plurality of antennas or an antenna array of a first network entity to form a plurality of beams and to concurrently transmit and receive on the plurality of beams, the plurality of beams including at least a first beam and a second beam,
communicating, by the first network entity, with one or more second network entities of the wireless communication network, and
sensing, by the first network entity, a surrounding of the first network entity using a reflection of a radio signal, wherein the sensing comprises:
transmitting the radio signal on the first beam which is directed into a first direction, and
directing the second beam into a second direction, the second direction pointing towards a reflector, the reflector receiving from the surrounding the reflection of the radio signal and directing the reflection of the radio signal towards the first network entity,
wherein the first direction into which the first beam is directed is different from the second direction into which the second beam is directed.

The present invention provides a method for serving a network entity of a wireless communication network which performs sensing and communicating, the method comprising:
serving, by a first network entity, one or more second network entities of the wireless communication network, the second network entity being configured to communicate with one or more third network entities of the wireless communication network, and to sense a surrounding of the second network entity using a reflection of a radio signal from the surrounding,
receiving, by the first network entity, a sensing request from the second network entity, and
sending, by the first network entity, to the second network entity information about a location of a reflector of the wireless communication network relative to the second network entity, e.g., in absolute of relative coordinates, or about an angle at which the second network entity is positioned relative to the reflector, the reflector receiving from the surrounding the reflection of the radio signal and directing the reflection of the radio signal towards the second network entity.

The present invention provides a computer program product comprising instructions which, when the program is executed by a computer, causes the computer to carry out one or more methods in accordance with the present invention.

Embodiments of the present invention are now described in more detail with reference to the accompanying drawing. It is noted that the subsequently outlined and described aspects or embodiments may be combined such that some or all of the aspects/embodiments are implemented within one embodiment.

A user-centric sensing embodiment is now described, i.e., a scenario where the sensing is performed by a user device or user equipment, UE. In general, mono-static sensing systems which employ multiple antennas allow for a certain level of spatial isolation by employing a spatial angle-of-arrival AoA difference between a transmitted signal and a signal reflected directly from the target. However, given the limited number of antenna elements or antennas of a UE, achieving a sufficient spatial AoA difference may be difficult. The self-interference due to the simultaneous transmission and reception may then not be handled properly, thereby causing, e.g., a saturation of a low-noise amplifier, LNA, or an analog-to-digital converter, ADC, in the UE. Embodiments of the present invention provide a network entity overcoming the above problems. The network entity, like the user device, forms at least two beams for receiving/transmitting concurrently, i.e., for operating in full-duplex. The beams are directed into different directions such that self-interference may be controlled to not exceed a certain threshold, wherein one beam is used for transmitting a radio signal into the UE's surrounding or into the UE's environment, and the other beam is used for receiving indirectly a reflection of the radio signal from the surrounding via a reflector which redirects the reflection such that it is received at the UE on the other beam, i.e., from a direction substantially different from the direction into which the UE transmits.

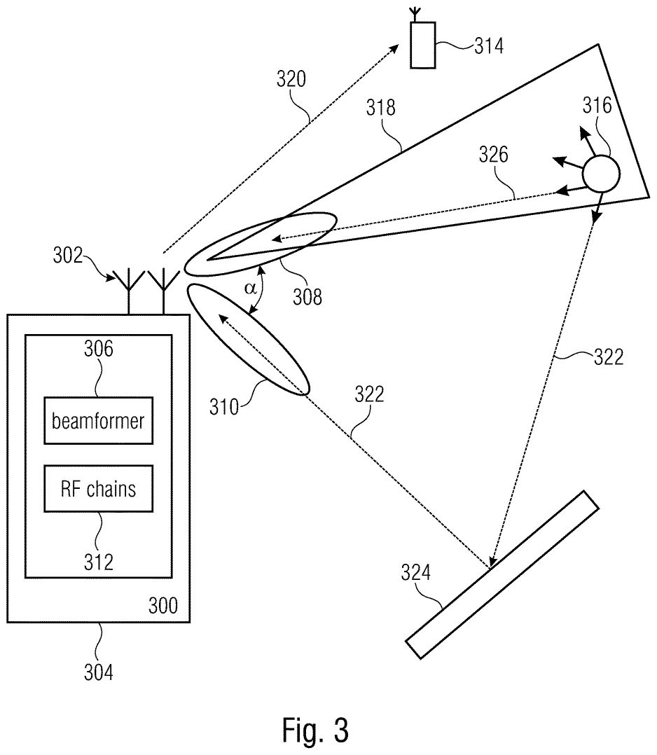

FIG. 3 illustrates a network entity in accordance with embodiments of the present invention. The network entity, e.g., a UE, BS, RUS or the like, forms at least two beams and receives/transmits concurrently, i.e., operates in full duplex. The beams are directed into different directions, with one beam being used for sending a radio signal into the surrounding of the network entity, and the other beam being used for sensing, i.e., receiving a reflection of the radio signal from the surrounding via a reflector which redirects the reflection such that it is received at the second entity on the second beam. FIG. 3 illustrates a network entity 300 in the form of a user device, UE, including a plurality of antennas or an antenna array having a plurality of antenna elements 302. The UE 300 includes a signal processing unit 304 including a beamformer 306 for controlling the plurality of antennas or the antenna array 302 to form a plurality of beams 308, 310 directed into different directions, as is indicated by α in FIG. 3. The first beam 308 may also be referred to as a transmit beam, and the second beam 310 may also be referred to as a receive beam. The UE 300 comprises one or more RF processing chains 312 for simultaneously or concurrently transmitting and receiving on the plurality of beams 308, 310.

The UE 300 communicates with one or more further network entities, for example with a further UE or with a base station 314, and senses its surrounding, e.g., one or more objects 416 located in the surrounding. In other words, the UE 300 may be referred to as an integrated communication and sensing, ISAC, UE.

The UE 300 transmits a radio signal 318, also referred to as a sensing signal, into its surrounding. The UE 300 also communicates via a communication signal with the further UE 314 for establishing a communication link 320 between the UE 300 and the further UE 314. The radio signal 318 is reflected by the object 316 into different directions as is schematically illustrated by the arrows originating from the object, and the UE 300 performs the sensing by detecting one or more of the reflections of the radio signal. For providing the angular separation α between the transmitted radio signal 318 and a reflection thereof, which is sufficient for keeping a self-interference within desired limits, the UE 300 receives a reflection 322 of the radio signal 318 indirectly via a reflector 324 so that the reflection 322 is received from a direction which is substantially different from the direction into which the UE 300 transmits the radio signal 318. The UE 300 forms the receive beam 310 such that it is directed into the direction of the reflector 324 directing the reflection 322 towards the UE 300. The UE 300 forms the respective beams 308 and 310 in such a way that a sufficient spatial isolation between the receive beam and the transmit beam is given thereby keeping the self-interference, SI, at the UE 300 within acceptable limits.

Thus, in accordance with embodiments, the UE 300 sets the first direction into which the first beam 308 is directed and the second direction into which the second beam 310 is directed such that a self-interference at the UE 300 does not exceed a certain threshold. For example, a SI threshold/spatial separation of the beams may be set dependent on a sensing distance. When sensing a closer/nearby environment a higher SI may be acceptable so that a smaller angle, e.g., 30°, between the beams 308, 310 may be selected, while for sensing a more distant environment the SI needs to be lower so that larger angle, e.g., 60°, between beams 308, 310 is selected. In other words, for sensing the surrounding of the network entity at a first, short distance from the UE 300, a first SI threshold applies causing the UE 300 to set the first and second beams 308, 310 such that the first and second directions are spatially separated by a small amount, like an angle of 30°. For sensing the surrounding of the network entity at a second, longer distance from the network entity a second threshold applies causing the UE 300 to set the first and second beams 308, 310 such that that the first and second directions are spatially separated by a large amount, like an angle of 60°.

In accordance with further embodiments, in addition to the indirect reflection 322 of the radio signal 318, the sensing process may use, in addition to the indirect reflection 322, a direct reflection 326 of the radio signal 3418 which is received on the first beam 308.

In the embodiment of FIG. 3, the UE 300 uses the radio signal 318 for sensing its surrounding or environment, and the communication with the further UE 314 uses a separate communication signal for establishing the link 320. In other words, the radio signal 318 is a sensing signal or comprises one or more sensing specific signals not associated with a communication between the UE 300 and the further UE 314 but used only for sensing the surrounding of the UE 300. For example, the one or more sensing specific signals may include on or more of the following:
one or more pilot signals, like Frank-Zadoff-Chu, FZC, sequences or Gold sequences,
one or more reference signals, like a Synchronization Signal Block, SSB, a Phase-tracking reference signal PTRS, a Channel state information reference signal CSI-RS, or a Positioning Reference Signal, PRS,
one or more data signals, like payload or control data for the second network entity.
linear frequency modulation, LFM, signals,
non-linear frequency modulation, NLFM, signals.

The present invention is not limited to using separate communication and sensing signals as described with reference to FIG. 3. Rather, in accordance with other embodiments, the radio signal may be a communication signal for a communication with the further UE, and reflections of the communication signal are received via the reflector and used by the UE for sensing its surrounding.

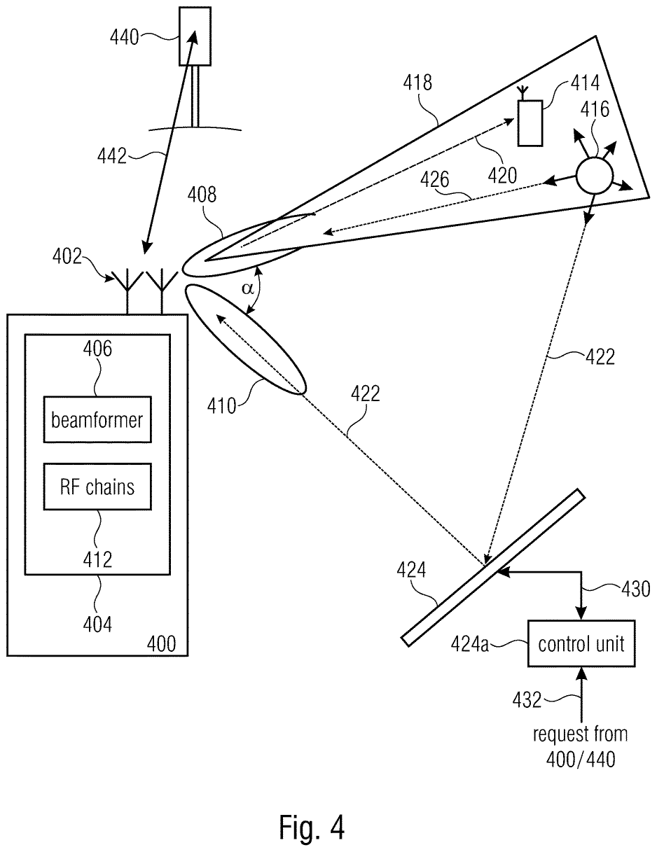

FIG. 4 illustrates a network entity in accordance with other embodiments of the present invention. The network entity, e.g., a UE, BS, RUS or the like, forms at least two beams and receives/transmits concurrently. i.e., operates in full duplex. The beams are directed into different directions, with one beam being used for sending a communication signal, the radio signal, to the other network entity, and with the other beam being used for sensing, i.e., receiving a reflection of the communication signal from the UE's surrounding via a reflector which redirects the reflection such that it is received at the UE on the second beam. In other words, the radio signal is a communication signal or comprises one or more communication specific signals associated with a communication between the UE and the further 314. For example, the one or more communication specific signals comprises on or more of the following:
one or more pilot signals, like Frank-Zadoff-Chu, FZC, sequences or Gold sequences,
one or more reference signals, like a Synchronization Signal Block, SSB, a Phase-tracking reference signal PTRS, a Channel state information reference signal CSI-RS, or a Positioning Reference Signal, PRS,
one or more data signals, like payload data for the second network entity.

FIG. 4 illustrates a network entity 400 in the form of a user device, UE, including a plurality of antennas or an antenna array having a plurality of antenna elements 402. The UE 400 includes a signal processing unit 404 including a beamformer 406 for controlling the plurality of antennas or the antenna array 402 to form a plurality of beams 408, 410 directed into different directions, as is indicated by α in FIG. 4. The first beam 408 may also be referred to as a transmit beam, and the second beam 410 may also be referred to as a receive beam. The UE 400 comprises one or more RF processing chains 412 for simultaneously or concurrently transmitting and receiving on the plurality of beams 408, 410.

The UE 400 communicates with one or more further network entities, for example with a further UE or with a base station 414, and senses one or more objects, like object 416, in the surrounding of the UE 400. In other words, the UE 400 may be referred to as an integrated communication and sensing, ISAC, UE.

The UE transmits a communication signal 418 towards the further UE 414 for establishing a communication link 420 between the UE 400 and the further UE 414. As is illustrated in FIG. 4, the commination signal 418 also illuminates the object 416. The commination signal 418 is reflected by the object 416 into different directions as is schematically illustrated by the arrows originating from the object, and the UE 400 performs the sensing by detecting one or more of the reflections of the communication signal 418. For providing the angular separation α between the communication signal 418 and a reflection thereof, which is sufficient for keeping a self-interference within desired limits, the UE 400 receives a reflection 422 of the communication signal 418 indirectly via a reflector 424 so that the reflection 422 is received from a direction which is substantially different from the direction into which the UE 400 transmits the communication signal 418. The UE 400 forms the receive beam 410 such that it is directed into the direction of the reflector 424 directing the reflection 422 towards the UE 400. The UE 400 forms the respective beams 408 and 410 in such a way that a sufficient spatial isolation between the receive beam and the transmit beam is given thereby keeping the self-interference, SI, at the UE 400 within acceptable limits.

Thus, in accordance with embodiments, the UE 400 sets the first direction into which the first beam 408 is directed and the second direction into which the second beam 410 is directed such that a self-interference at the UE 400 does not exceed a certain threshold. For example, a SI threshold/spatial separation of the beams may be set dependent on a sensing distance. When sensing a closer/nearby environment a higher SI may be acceptable so that a smaller angle, e.g., 30°, between the beams 408, 410 may be selected, while for sensing a more distant environment the SI needs to be lower so that larger angle, e.g., 60°, between beams 408, 410 is selected. In other words, for sensing the surrounding of the network entity at a first, short distance from the UE 400, a first SI threshold applies causing the UE 400 to set the first and second beams 408, 410 such that the first and second directions are spatially separated by a small amount, like an angle of 30°. For sensing the surrounding of the network entity at a second, longer distance from the network entity a second threshold applies causing the UE 400 to set the first and second beams 408, 410 such that that the first and second directions are spatially separated by a large amount, like an angle of 60°.

In accordance with further embodiments, in addition to the indirect reflection 422 of the communication signal 318, the sensing process may use, in addition to the indirect reflection 422, a direct reflection 426 of the communication signal 418 which is received on the first beam 408.

The present invention is not limited to using for the sensing process a communication signal including only communication specific signals, as described with reference to FIG. 4. Rather, in accordance with yet other embodiments, the communication signal as used in the embodiment of FIG. 4 may include, in addition to the communication specific signals, like the above-mentioned pilot signals, reference signals or data signals, also one or more of the above-mentioned sensing specific signals which are not associated with a communication between the UE 400 and the further UE 414. For example, such sensing specific signals may be located on time/frequency resources of the communication signal which are unused, i.e., do not carry any information associated with the communication between the UE and the further UE.

The sensing of the surrounding of the UE 300, 400 using the reflection of the radio/communication signal 318, 418 may include:
detecting one or more objects or living beings within the surrounding, and/or
obtaining information about characteristics of the surrounding and/or one or more objects or living beings within the surrounding.

For example, the characteristics of the one or more objects or living beings within the surrounding of the UE 300, 400 may include one or more of the following:
a shape of an object/living being,
a size of an object/living being,
an orientation of an object/living being,
a speed of an object/living being,
a location of an object/living being, e.g., determining a position of an object/living being relative to the network entity or in absolute coordinates
a distance between an object/living being and the network entity,
a relative motion between objects/living beings,
a condition of an object/living, e.g., for determining to what degree a sensed condition corresponds to an expected condition of an object/living, like a human motion rate accuracy describing a closeness of a measured value of a human body movement frequency caused by parts of the e. human body to the true value of the human body movement frequency,
an image of an object/living being, such as an object material type,
a mapping of the one or more objects/living beings, e.g., for an environmental mapping.

The characteristics of the surrounding may include one or more of the following:
a weather condition in the surrounding, e.g., a precipitation, like rain or snow fall, in the surrounding,
a geographical nature of the surrounding, like a slope, a vegetation.

In accordance with embodiments, the one or more objects/living beings sensed by the UE 300, 400 may include one or more of the following:
the further UE 314, 414 network with which the UE 300, 400 communicates,
another network entity of the wireless communication network with which the UE 300, 400 does not communicate,
an obstacle or a person in the surrounding of the network entity, e.g.,
   an obstacle or a person in a trajectory of the network entity, or
   an obstacle or a person blocking a communication link with the second network.

The reflector 324 of FIG. 3 is a non-configurable reflector, for example the reflector 324 may be a static surface. The reflector 424 of FIG. 4 is a configurable reflector which is controllable to receive a signal from one direction and/or transmit a signal to another direction. For example, the reflector 424 may be a reconfigurable intelligent surface, RIS, or an intelligent reflecting surface, IRS. In accordance with yet other embodiments, the reflector 324, 424 may be a relay device, for example an amplify and forward relay node. It is noted that in the embodiment of FIG. 3 a configurable reflector or a relay device may be used instead of the non-configurable reflector, and in the embodiment of FIG. 4 a non-configurable reflector or a relay device may be used instead of the configurable reflector.

The configurable reflector 424 has elements which may be configured for directing a signal into a desired direction, the UE 400 may cause a configuration of the active reflector 424 so that the reflection 422 of the communication signal 418 reflected by the obstacle 416 is directed towards the UE 400. In accordance with embodiments, the UE 400 may send a request to a further network entity for causing an appropriate configuration of the active reflector 424. For example, the request may be transmitted to a base station serving the UE 400 which, in turn, causes the reflector 424 to adjust its reflector elements accordingly. In accordance with other embodiments, the request may be provided to a control unit 424a of the reflector, as is indicated at 432 in FIG. 4 for causing the reflector 424 to configure its reflector elements accordingly. In accordance with yet other embodiments, the UE 400 may directly request the reflector 424 for an appropriate configuration of its reflector elements, for example, by sending a configuration message directly to the reflector 424.

In accordance with embodiments, the UE 300, 400 forms, by means of the beamformer 406, the second or receive beam 410 using information about (1) a location, like a geographical location, of the reflector 324, 424 within the wireless communication network or (2) an angle at which the network entity is positioned relative to the reflector. In accordance with embodiments, the UE 300, 400 knows the position of the reflector or the angle towards the reflector, for example, it may be preconfigured with the position or angle. For example, the position or the angle may be obtained during an initial access of the UE 300, 400 to the wireless communication network. In accordance with other embodiments, the information about the reflector's position or angle may be received from the network, for example, the UE 300, 400 may be configured to receive information about the location or angle of the reflector 324, 424 relative to the UE 300, 400. On the basis of a position at which the UE 300, 400 is located and on the basis of the information about the location or angle, for example by evaluating the respective geographical locations of the UE 300, 400 and the reflector 324, 424, the UE 300, 400 is able to determine a direction into which the second beam 310, 410 is to be directed so as to receive the reflection 322, 422 of the data/communication signal 318, 418 redirected by the reflector 324, 424 towards the UE 300, 400.

In accordance with further embodiments, UE 300, 400 may be a UE which is capable of changing its location, i.e., it may be a moving or vehicular UE. When the UE 300, 400 is moving, it updates the direction into which the beam 310, 410 points so as to keep it pointing towards the reflector 324, 424 while moving. In this situation, the UE 300, 400 may use the preconfigured position or angle of the reflector within the wireless communication network for adapting or adjusting the beam 310, 410, or it may operate responsive to updated information about the location or angle of the reflector 324, 424 relative to the UE 300, 400 which is received from the network side.

In accordance with embodiments, the information or the updated information about the location or angle of the reflector 324, 424 relative to the UE 300, 400 may be obtained from a further network entity, for example from the control unit 424a associated with the reflector 424, or from a further network entity, for example from a base station serving the UE 300, 400 and providing a corresponding configuration message to the UE 300, 400. In accordance with yet other embodiments, the location or angle information may be received directly from the reflector 424.

In accordance with embodiments, the UE 300, 400 may determine the beam 310, 410 using a certain search mechanism, for example for selecting the beam 310, 410 from a codebook of available beams or from a lookup table that stores historical information.

In accordance with yet further embodiments, the UE 300, 400 may sweep the first and/or second beams 308, 310, 408, 410 so as to perform a sensing in two or more directions.

Embodiments of the present invention implement a mobile UE sensing approach which is assisted by a base station and employs as a reflector a base station controlled RIS or IRS. FIG. 4 illustrates a base station 440 serving, the UE 400, as is indicated at 442, i.e., UE 400 is assumed to be in coverage of base station 440.

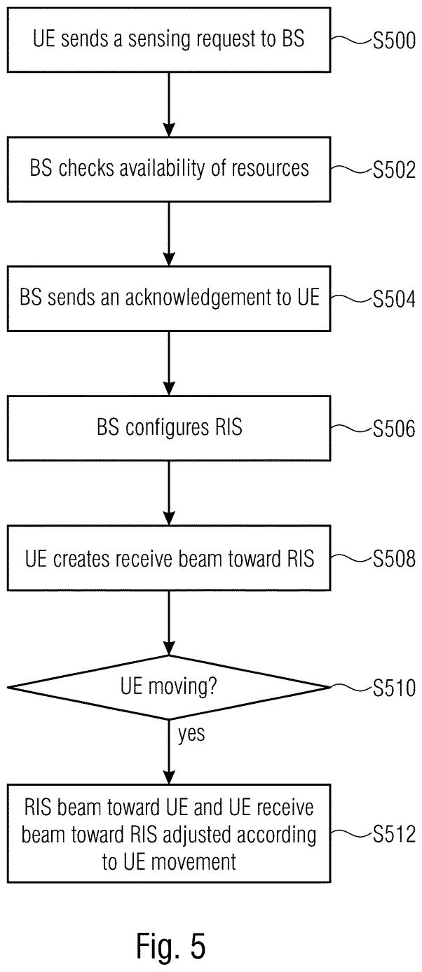

FIG. 5 is a flow diagram illustrating the base station assisted operation of the ISAC UE 400 of FIG. 4. Initially, at step S500, the UE 400 sends a sensing request to the base station 440. At step S502 the base station 440 checks an availability of resources for the operation, e.g., it identifies one or more reflectors 424 which are available and calculates the available resources. At step S504, the base station 440 sends an acknowledgement message to the UE 440 which contains metadata about the physical location of the RIS 424. At step S506 the base station 440 configures the RIS 424 via the RIS control unit 424a, as is indicated at 432 in FIG. 3 such that the RIS 424 collects a reflected signal, the reflection 422, from the illuminated target or object 416 and directs it towards the UE 400. At step 508, responsive to the received metadata from the base station 440, the UE creates the receive beam 410 which is directed towards the RIS 424.

In accordance with embodiments, when the UE 400 is a moving UE, it is determined at step S510 whether the UE is moving, for example, whether a position of the UE changed when compared to an earlier position by a predetermined amount. When the UE 400 moves, at step 510 both the reflector 424 and the UE 400 are adjusted so as to ensure that any reflection is continuously directed from the reflector 424 towards the UE 400 and that the receive beam 410 continuously points towards the reflector 424. In accordance with further embodiments, the base station 404 has knowledge about the location of the reflector 424 and about a current location of the UE 400 so as to control the reflector 424 such that the reflector constantly directs the reflection towards the moving UE 400.

Further embodiments of the present invention are now described with reference to a specific use case in accordance with which the UE is a vehicular UE, e.g., is part of a vehicle which needs to do sensing and communication at the same time. In such use cases, respective reflectors, like RISs, may be deployed at the sides of streets for providing the sensing link relaxing the self-interference cancellation requirement as explained above. For example UEs having a plurality of antennas or multiple phased arrays may use one array for transmitting and one array for receiving so as to take advantage of reflectors, like an RIS, on facades of buildings or indoor installed reflectors. In accordance with embodiments of the present invention, a first use case concerns a vehicle-to-vehicle communication over the sidelink.

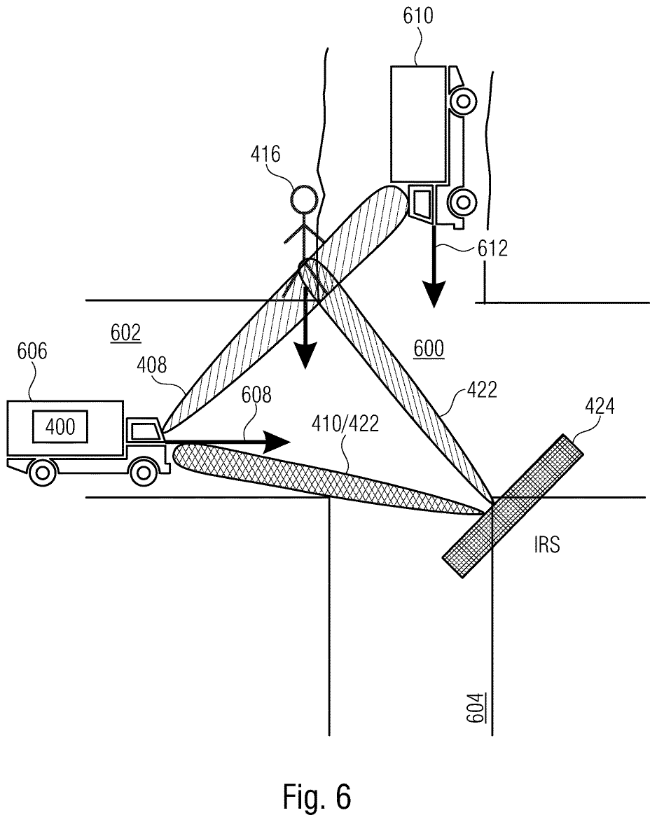

FIG. 6 illustrates a vehicle-to-vehicle communication implementing the inventive approach. FIG. 6 illustrates an intersection 600 of a first street 602 and a second street 604. At one corner of the intersection 600 the reflector 424 is installed in the form of an intelligent reflective surface, RIS, device allowing a configuration for directing an incident signal or beam into a desired direction. In FIG. 6 a situation is assumed in which a first vehicle 606 travels towards the intersection 600 as is indicated by arrow 608, and a second vehicle 610 also approaches the intersection as is indicated at 612. The first vehicle 606 includes the inventive UE 400 or operates in accordance with the inventive approach for performing both communication and sensing. For the communication with the vehicle 610, the vehicle 606 generates and uses the first beam 408. The communication signal transmitted using beam 408 is reflected at an obstacle 416, in the depicted embodiment, a pedestrian waiting at the corner of the intersection 600 opposite the reflector 424 and intending to cross the street 602. The communication signal is reflected by the pedestrian 416 towards the reflector 424 and directed by the reflector 424 to the UE 400/vehicle 606, as indicated at 422.

The scenario depicted in FIG. 6 allows for an enhancement of the road safety and traffic efficiency by means of cooperative intelligent transport systems and services, C-ITS. The cooperative road traffic is based on the vehicle-to-vehicle communication, V2V, and, further, is supported by a vehicle-to-infrastructure communication, V2I. The scenario illustrated in FIG. 6 highlights the benefits of the use of an ISAC UE when considering the intersection 600 approached by the vehicles 606 and 610. Based on predefined policies and/or protocols, the vehicle 606 is communicating with the vehicle 610 using the transmit beam 408 so as to cause the vehicle 610 also approaching the intersection 600 to reduce its speed so that the vehicle 606 may uninterruptedly continue its way across the intersection 600 on street 602. While the vehicle 606 is capable of communicating with the vehicle 610, there may be other obstacles in its path or potentially entering its path which are passive in the sense that they do not send out any signal that may be detected by the vehicle 606. For example, as depicted in FIG. 6, such obstacles may be one or more pedestrians which intend to cross the intersection 600 at a time at which the vehicle 606 intends to cross the intersection. For dealing with such passive obstacles or persons, the sensing of the actual environment around or ahead of the vehicle 606 is of upmost importance to avoid potential collisions and ensure safety. In a scenario as depicted in FIG. 6, the vehicle 606 senses the environment, more specifically the intersection 600, and a reflection of the communication is directed via the RIS 424 towards the vehicle 606 thereby allowing the vehicle 606 to detect the pedestrian 416 and to take appropriate action, like slowing down, stopping or making an evasive movement. Naturally, other obstacles may be sensed in this way. Thus, one can see in FIG. 6 that by means of the communication link over beam 408 a communication between the vehicles 606 and 610 is performed, while the sensing of the obstacle/pedestrian 416 is performed via the sensing link extending from the obstacle via the RIS 424 towards the vehicle 606/UE 400.

Although the above embodiment has been described with reference to the vehicle 606 including the UE 400, it is noted that the UE 400 may also be UE 300 described above with reference to FIG. 3 and may actually be considered a vehicle UE, i.e., the vehicle 606 may be configured for implementing the inventive communication/sensing approach in a way as described above with reference to FIG. 4.

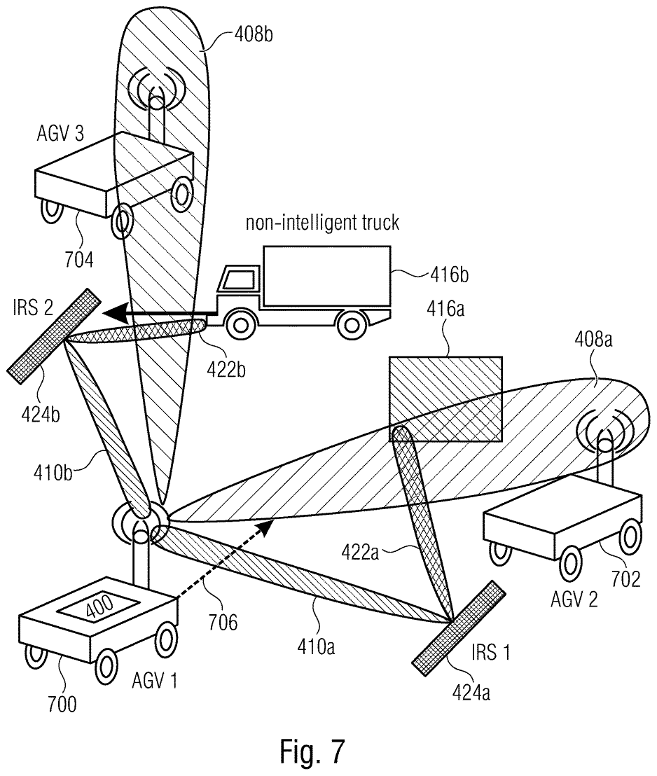

Another use case in accordance with embodiments of the present invention is illustrated in FIG. 7 showing the implementation of ISAC in a campus network. Campus networks are customized mobile networks, for example for the industry sector, the research sector and the public sector. Campus networks allow an instantaneous communication between machines and processes which is essential to facilitate the processes and make them as fast and efficient as possible. For example, automated guided vehicles, AGVs, are used in factories for moving around and performing certain tasks. In such a process, an essential aspect for ensuring efficiency as well as safety is a constant communication among the AGVs as well as with the infrastructure. Leveraging the communication possibility and based on given protocols, the AGVs may determine their trajectory, use resources and split tasks. However, similar to any development progress there may be other elements, like legacy elements in the network, which may be obstacles, or walls in a factory environment, or passive or non-intelligent elements, e.g., non-transmitting vehicles like a truck being unloaded or loaded at the factory. Therefore, besides the communication with fellow intelligent UEs/infrastructure, the AGVs also need to sense and detect other non-intelligent elements in their surroundings.

FIG. 7 illustrates a scenario in which a first AGV 700 may operate according to the present invention or may have implemented an ISAC UE 300 or 400. The AGV has an antenna structure which is capable to form a plurality of beams, more specifically a first transmit beam 408a directed towards the AGV 702 forming a receiving entity for a wireless communication with AGV 700, and a second transmit beam 408b for a communication with the AGV 704. It is assumed that two reflectors 424a and 424b are installed at certain locations within the factory, for example in the form of respective IRSs. The AGV 700 is capable to form a first receive beam 410a directed to reflector 424a and a second receive beam 410b directed towards the second reflector 424b. In the surroundings where the respective AGVs move, respective obstacles 416a and 416b exist. Obstacle 416a is a stationary obstacle, like a factory wall or the like, while obstacle 416b is a non-intelligent moveable obstacle, like a truck moving through the environment in which the AGVs also move. FIG. 7 illustrates the vital role of ISAC in maintaining safety by using the inventive approach of combining ISAC with the respective reflectors 424a and 424b. More specifically, while AGV 700 is communicating with AGV 702, a reflection 422a of the communication signal transmitted via transmit beam 408a is received at IRS 424a and directed by IRS 424a to the AGV 700 which receives the reflected communication signal on its receive beam 410a. On the basis of the reflected signal, AGV 700 detects the obstacle 416a on its trajectory 706, thereby allowing AGV 700 to re-route its trajectory to avoid a collision.

Further, the ISAC combined with the reflector may be used for avoiding any communication interruption. For example, AGV 700 may communicate with AGV 704 using a communication signal transmitted on transmit beam 408b. The communication signal may be reflected at the moving vehicle 416b, and the reflection 422b is directed by the IRS 424b towards the AGV 700 which detects the reflected signal and thereby the obstacle 416b on the basis of the reflection received on its receive beam 410b. Thus, while the AGV 700 is communicating with AGV 704, the IRS 424b allows AGV 700 to detect the unintelligent moving truck 416b which may potentially block the link between the AGVs 700 and 704 so that the AGV 700 can take appropriate measures to find another link for keeping the communication link with AGV 704 uninterrupted.

In the embodiments described so far, the integrated sensing and communication has been described to be implemented by a user device. However, the present invention is not limited to such embodiments. Rather, in accordance with other embodiments, the inventive approach may be implemented in any kind of network entity, for example also in a base station.

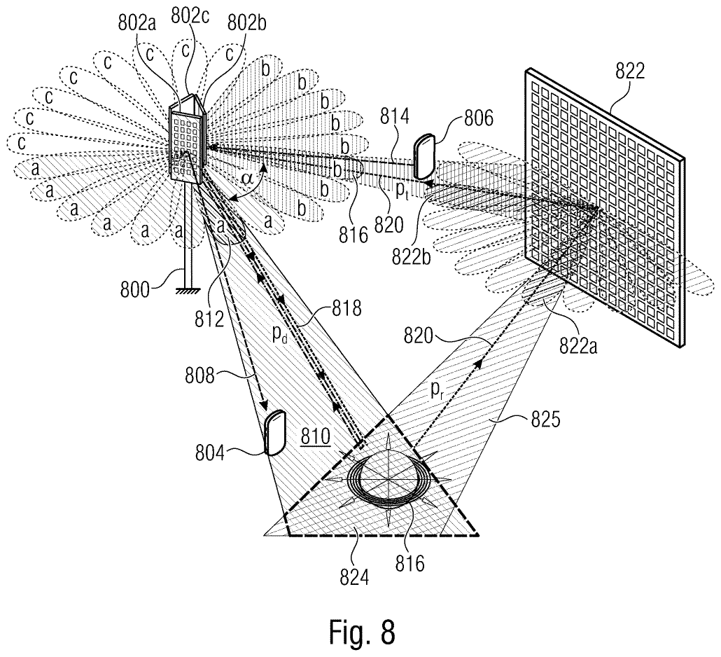

FIG. 8 illustrates an embodiment of the present invention being implemented in a base station. More specifically, FIG. 8 illustrates a base station 800 having three antenna arrays 802a to 802c, each comprising a plurality of antenna elements which may be controlled by a beamformer implemented in the base station 800 for generating or forming a plurality of beams. In the figure, the beams which may be formed using the antenna array 802a are labelled “a”, the beams that may be formed using antenna array 802b are labelled “b” and the beams that may be formed using the antenna array 802c are labelled “c”. The base station, in the depicted embodiment, serves a plurality of user devices, UEs, namely UE 804 and UE 806. The base station 800 performs a downlink transmission 808 towards the UE 804 using the Uu interface by sending a communication signal 810 on a transmit beam 812 formed by antenna array 802a. The base station 800 receives an uplink communication 814 from the UE 806 on a receive beam 816 formed by the antenna array 802b. As is illustrated in FIG. 8, the communication signal 810 also illuminates a location of interest containing an object 816 with an unknown location. The communication signal 810 may be reflected on a direct path 818 between the object 816 and the base station 800 as it may be experienced in a conventional mono-static sensing approach resulting in general in an inacceptable lever of SI. Therefore, in accordance with the inventive approach, an additional, indirect path 820 is provided via which the communication signal 810 is reflected towards a reflector 822 which redirects the reflected communication signal towards the receive beam 816 of the base station 800. As may be seen from FIG. 8, the reflector 822 receives the communication signal reflected by the object 816 from a first direction 822a and redirects the reflected signal into a second direction 822b pointing into the direction into which the received beam 816 of the base station is directed. Thus, the reflected communication signal is received with a spatial separation α from the transmit beam thereby keeping the self-interference within desired limits and allowing the base station 800 to detect the object 816. Thus, for sensing its surrounding, the base station operates in the same way as the UE 400 described above with reference to FIG. 4.

In accordance with embodiments, the reflector 822 may be an RIS or IRS having configurable elements so as to control at least direction 822b so as to have it aligned with receive beam 816. Further, the reflector 822 may be controlled with regard to the receiving direction 822a. For example, in FIG. 8 the region of interest extends a first distance beyond the UE 804 and is illustrated in FIG. 8 schematically at 824 at the intersection of the area covered by a transmission of beam 812 in an area covered by beam 825.

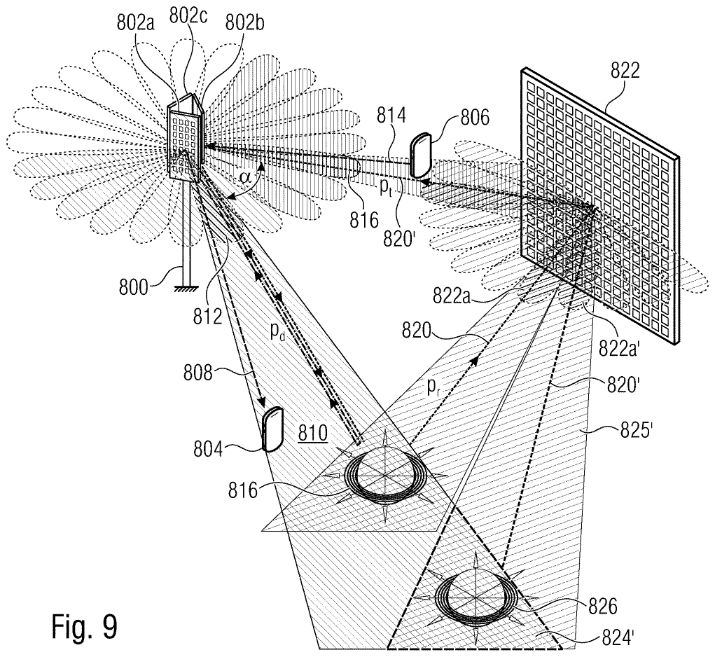

In accordance with embodiments, the region of interest may be increased by applying an RIS sweeping process. FIG. 9 illustrates an RIS sweeping approach in accordance with embodiments of the present invention. The scenario in FIG. 9 basically corresponds to the one described above with reference to FIG. 8, except that the RIS 822 is controlled, for example, by the base station 800, so as to perform an RIS sweeping, meaning that the receive beam 822a is swept so as to be directed into a different direction as is illustrated in FIG. 9 so that the region of interest is now further outward of the obstacle 816, as is illustrated at 824'. Also, in this region 824', the communication signal 810 is reflected at obstacles, like obstacle 826, and the reflected communication signal 820′ is directed via the RIS 822 towards the receive beam 816 of the base station 800.

In accordance with yet other embodiments, the base station may perform beam sweeping.

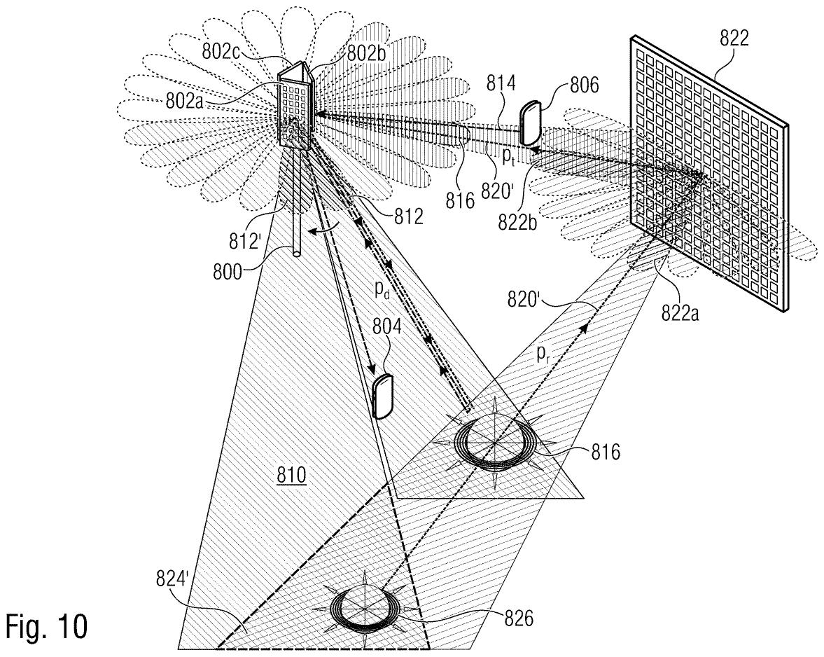

FIG. 10 illustrates an embodiment of a beam sweeping by the base station in accordance with embodiments of the present invention. The scenario is the same as in FIG. 8, however, for sensing a larger region of interest, the base station 800 sweeps the transmit beam 812 to the position illustrated at 812′ while maintaining the configuration of the IRS 822 unchanged, thereby defining the additional region of interest 824'. Objects, like object 826 located in the additional region of interest 824′ reflect the communication signal transmitted by transmit beam 812′ and the reflected communication signal 820′ is transmitted via the reflector 822 to the base station 800 which receives the reflected communication signal 820′ on its receive beam 816.

In accordance with other embodiments, the base station of FIG. 10 may not perform a beam sweep but operate in the way as the UE 300 described above with reference to FIG. 3. More specifically, the base station 800 forms both the transmit beam 812 and the transmit beam 812′, transmits the communication signal for a communication with the UE 804 using the transmit beam 812 and transmits a data or sensing signal using the transmit beam 812′, i.e., the communication and the sensing employ different radio signals as described above with reference to FIG. 3.

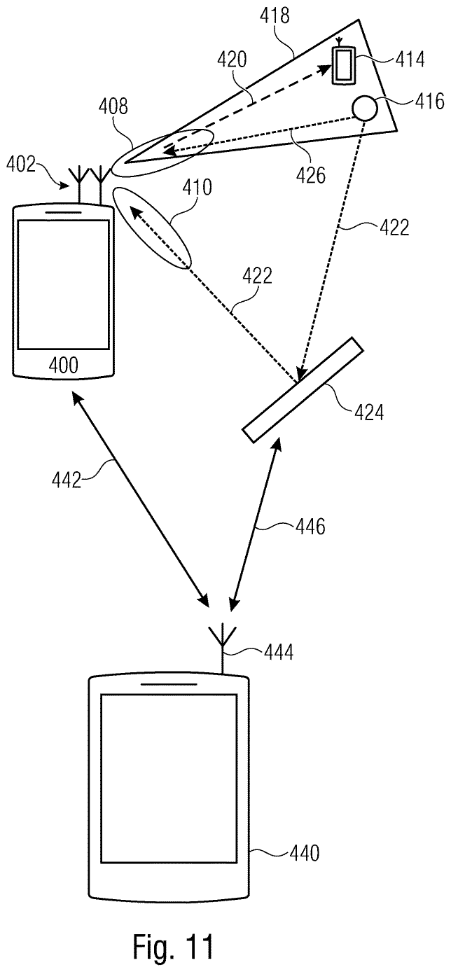

Further embodiments of the present invention provide a network entity, like a base station or a roadside unit or a group leader UE, which is provided for serving an ISAC UE and providing at least information about a location or angle of the reflector employed in accordance with the inventive approach for supporting the operation of the ISAC UE. FIG. 11 illustrates a base station in accordance with embodiments of the present invention, e.g., the base station 440 of FIG. 4. The base station 440 has one or more antennas 444 or an antenna array including one or more antenna elements. As is schematically illustrated at 442, the base station 440 is serving the ISAC UE 400, which has been described in detail above with reference to FIG. 4. The base station 440 receives from UE 400 a request for sensing, and responsive to this request, the base station 440, which knows the position or angle of the reflector 424 in the network, sends to the UE 400 information about the location or angle of the reflector, for example the position in absolute or relative coordinates.

In accordance with further embodiments, in case of a change of a position of the UE 400, for example when the UE is a moving entity, the base station 440 may send updated information about the location or angle of the reflector 424 relative to the UE 400.

In accordance with further embodiments, a plurality of reflectors 424 may be located within the wireless communication network, and, based on a position of the UE 400 which is known at the base station 440, the base station 440 identifies one or more reflectors available for cooperating with the UE 400. In case the reflectors are configurable devices comprising configurable reflector elements, the base station 440 controls the reflector 424, as is indicated at 446, so as to cause the reflector 424 to direct the received reflection 422 towards the UE 400. In case the UE 400 is a moving entity and changes its position, the base station 440 may control the reflector 424 so that a reflection 422 received at the reflector 424 keeps pointing towards the moving UE 400. In accordance with embodiments, the base station 440 may adjust reflection direction of the reflector 424 continuously while the UE 400 is moving, for example when determining that a position of the UE 400 changed by a predefined amount. In accordance with further embodiments, the reflection direction of the reflector 424 may be adjusted periodically, e.g., based on a maximum predefined speed of the UE 400 and a known beamwidth., or at predefined time intervals, e.g., when the environment or distribution of UEs is different at certain times.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof. Further, the wireless communication system may by a system or network different from the above described 3GPP mobile communication systems, rather, embodiments of the inventive approach may also be implemented in any other wireless communication network, e.g., in a private network, such as an Intranet or any other type of campus networks, or in a WiFi communication system.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, like a station (STA), access point (AP), node or mesh node, or mesh point, or Mesh AP, or any sidelink capable network entity.

In accordance with embodiments of the present invention, a base station comprises one or more of the following: a macro cell base station, or a small cell base station, or a central unit of a base station, an integrated access and backhaul, IAB, node, or a distributed unit of a base station, or a road side unit (RSU), or a Wi-Fi device such as an access point (AP) or mesh node (Mesh AP), or a remote radio head, or an AMF, or a MME, or a SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear, that these aspects also represent a description of the corresponding method, where a block or a device corresponds to a method step or a feature of a method step. Analogously, aspects described in the context of a method step also represent a description of a corresponding block or item or feature of a corresponding apparatus.

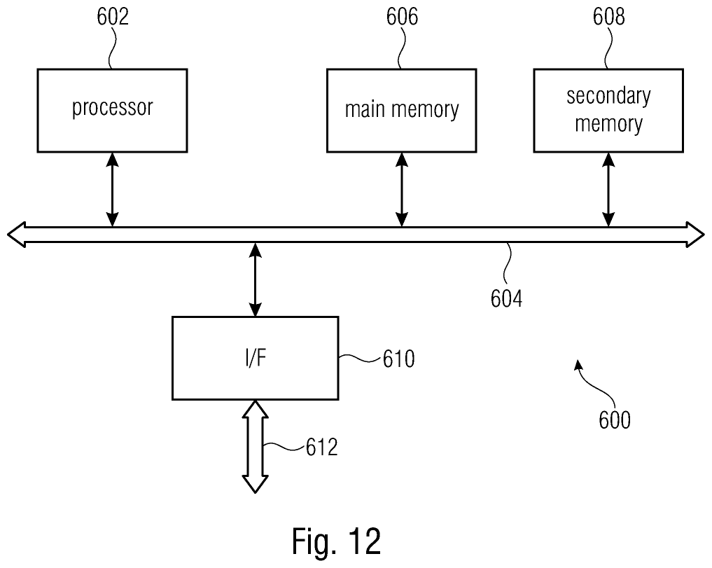

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] J. I. Choi et al. “Achieving single channel, full duplex wireless communication”. In: Proceedings of the sixteenth annual international conference on Mobile computing and networking. MobiCom '10. Chicago, Illinois, USA: ACM, 2010, pp. 1-12. isbn: 978-1-4503-0181-7. doi: 10.1145/1859995. 1859997 (cit. on p. 1).
[2] M. Duarte and A. Sabharwal. “Full-duplex wireless communications using off-the-shelf radios: Feasibility and first results”. In: 2010 Conference Record of the Forty Fourth Asilomar Conference on Signals, Systems and Computers (ASILOMAR). 2010, pp. 1558-1562. doi: 10.1109/ACSSC. 2010.5757799 (cit. on p. 3).
[3] E. Everett et al. “Empowering full-duplex wireless communication by exploiting directional diversity”. In: 2011 Conference Record of the Forty Fifth Asilomar Conference on Signals, Systems and Computers (ASILOMAR). November 2011, pp. 2002-2006. doi: 10.1109/ACSSC.2011.6190376 (cit. on p. 2).
[4] M. Jain et al. “Practical, real-time, full duplex wireless”. In: Proceedings of the 17th annual international conference on Mobile computing and networking. MobiCom '11. Las Vegas, Nevada, USA: ACM, 2011, pp. 301-312. isbn: 978-1-4503-0492-4. doi: 10.1145/2030613.2030647 (cit. on p. 2).
[5] M. A.″. In: Proceedings of the 10th ACM Workshop on Hot Topics in Networks. Khojastepour et al. “The Case for Antenna Cancellation for Scalable Full-duplex Wireless Communications HotNets-X. Cambridge, Massachusetts: ACM, 2011, 17:1-17:6. isbn: 978-1-4503-1059-8. doi: 10.1145/2070562.2070579 (cit. on p. 1).
[6] A. Sahai, G. Patel, and A. Sabharwal. Pushing the limits of Full-duplex: Design and Real-time Implementation. Technical report. Rice University, July 2011 (cit. on pp. 2, 3).
[7] M. Duarte, C. Dick, and A. Sabharwal. “Experiment-Driven Characterization of Full-Duplex Wireless Systems”. In: Wireless Communications, IEEE Transactions on 11.12 (December 2012), pp. 4296-4307. issn: 1536-1276. doi: 10.1109/TWC.2012.102612.111278 (cit. on p. 3).
[8] K. E. Kolodziej et al. “Ring array antenna with optimized beamformer for Simultaneous Transmit And Receive”. In: Antennas and Propagation Society International Symposium (APSURSI), 2012 IEEE. July 2012, pp. 1-2. doi: 10.1109/APS.2012.6349146 (cit. on p. 2).
[9] J. G. McMichael and K. E. Kolodziej. “Optimal tuning of analog self-interference cancellers for full-duplex wireless communication”. In: 2012 50th Annual Allerton Conference on Communication, Control, and Computing (Allerton). October 2012, pp. 246-251. doi: 10.1109/Allerton.2012. 6483225 (cit. on p. 4).
[10] A. Sahai et al. “Understanding the impact of phase noise on active cancellation in wireless full-duplex”. In: 2012 Conference Record of the Forty Sixth Asilomar Conference on Signals, Systems and Computers (ASILOMAR). November 2012, pp. 29-33. doi: 10.1109/ACSSC.2012.6488952 (cit. on p. 3).
[11] E. Ahmed, A. M. Eltawil, and A. Sabharwal. “Self-interference cancellation with nonlinear distortion suppression for full-duplex systems”. In: 2013 Asilomar Conference on Signals, Systems and Computers. November 2013, pp. 1199-1203. doi: 10.1109/ACSSC.2013.6810483 (cit. on pp. 3, 5).
[12] E. Ahmed, A. M. Eltawil, and A. Sabharwal. “Self-interference cancellation with phase noise induced ICI suppression for full-duplex systems”. In: Global Communications Conference (GLOBECOM), 2013 IEEE. December 2013, pp. 3384-3388. doi: 10.1109/GLOCOM.2013.6831595 (cit. on p. 3).
[13] L. Anttila et al. “Cancellation of power amplifier induced nonlinear self-interference in full-duplex transceivers”. In: 2013 Asilomar Conference on Signals, Systems and Computers. November 2013, pp. 1193-1198. doi: 10.1109/ ACSSC.2013.6810482 (cit. on pp. 3, 5).
[14] D. Bharadia, K. R. Joshi, and S. Katti. “Full Duplex Backscatter”. In: Proceedings of the Twelfth ACM Workshop on Hot Topics in Networks. HotNets-XII. College Park, Maryland: ACM, 2013, 4:1-4:7. isbn: 978-1-4503-2596-7. doi: 10.1145/2535771.2535785 (cit. on p. 4).
[15] D. Bharadia, E. McMilin, and S. Katti. “Full duplex radios”. In: Proceedings of the ACM SIGCOMM 2013 conference on SIGCOMM. SIGCOMM '13. Hong Kong, China: ACM, 2013, pp. 375-386. isbn: 978-1-4503-2056-6. doi: 10.1145/2486001.2486033 (cit. on pp. 2, 4, 5).
[16] Y. Hua et al. “Breaking the Barrier of Transmission Noise in Full-Duplex Radio”. In: Military Communications Conference, MILCOM 2013-2013 IEEE. November 2013, pp. 1558-1563. doi: 10.1109/MILCOM.2013.263 (cit. on p. 3).
[17] D. Korpi et al. “Advanced self-interference cancellation and multiantenna techniques for full-duplex radios”. In: 2013 Asilomar Conference on Signal, Systems and Computers. November 2013, pp. 3-8. doi: 10.1109/ACSSC.2013. 6810217 (cit. on p. 2).
[18] A. Sahai et al. “On the Impact of Phase Noise on Active Cancelation in Wireless Full-Duplex”. In: Vehicular Technology, IEEE Transactions on 62.9 (November 2013), pp. 4494-4510. issn: 0018-9545. doi: 10.1109/TVT. 2013.2266359 (cit. on p. 3).
[19] R. Askar et al. “Active self-interference cancellation mechanism for fullduplex wireless transceivers”. In: Oulu, Finland: IEEE, 2014, pp. 539-544. isbn: 978-1-6319-0003-7 (cit. on p. 3).
[20] R. Askar et al. “I/Q imbalance calibration for higher self-interference cancellation levels in Full-Duplex wireless transceivers”. In: Akaslompolo, Finland: IEEE, 2014, pp. 92-97. isbn: 978-1-6319-0055-6. doi: 10.4108/icst. 5gu.2014.258148 (cit. on p. 3).
[21] D. Bharadia and S. Katti. “Full Duplex MIMO Radios”. In: 11th USENIX Symposium on Networked Systems Design and Implementation (NSDI 14). Seattle, WA: USENIX Association, April 2014, pp. 359-372. isbn: 978-1-931971-09-6. url: https://www.usenix.org/conference/nsdi14/technicalsessions/bharadia (cit. on p. 4).
[22] N. A. Estep et al. “Magnetic-free non-reciprocity and isolation based on parametrically modulated coupled-resonator loops”. In: Nat Phys 10.12 (December 2014), pp. 923-927. issn: 1745-2473. url: http://dx.doi.org/10. 1038/nphys3134 (cit. on p. 2).
[23] E. Everett, A. Sahai, and A. Sabharwal. “Passive Self-Interference Suppression for Full-Duplex Infrastructure Nodes”. In: Wireless Communications, IEEE Transactions on PP.99 (2014), pp. 1-15. issn: 1536-1276. doi: 10.1109/TWC.2013.010214.130226 (cit. on p. 2).
[24] A. Gholian, Y. Ma, and Y. Hua. “A numerical investigation of all-analog radio self-interference cancellation”. In: Signal Processing Advances in Wireless Communications (SPAWC), 2014 IEEE 15th International Workshop on. June 2014, pp. 459-463. doi: 10.1109/SPAWC.2014.6941881 (cit. on p. 4).
[25] Y. Hua et al. “Blind digital tuning for interference cancellation in fullduplex radio”. In: 2014 48th Asilomar Conference on Signals, Systems and Computers. November 2014, pp. 1691-1695. doi: 10.1109/ACSSC.2014.7094755 (cit. on p. 4).
[26] K. E. Kolodziej, J. G. McMichael, and B. T. Perry. “Adaptive RF canceller for transmit-receive isolation improvement”. In: Radio and Wireless Symposium (RWS), 2014 IEEE. January 2014, pp. 172-174. doi: 10.1109/ RWS.2014.6830069 (cit. on p. 4).
[27] D. Korpi et al. “Full-Duplex Transceiver System Calculations: Analysis of ADC and Linearity Challenges”. In: Wireless Communications, IEEE Transactions on PP.99 (2014 ), pp. 1-1. issn: 1536-1276. doi: 10.1109/ TWC.2014.2315213 (cit. on pp. 3, 5).
[28] D. Korpi et al. “Widely Linear Digital Self-Interference Cancellation in Direct-Conversion Full-Duplex Transceiver”. In: Selected Areas in Communications, IEEE Journal on 32.9 (September 2014), pp. 1674-1687. issn: 0733-8716. doi: 10.1109/JSAC.2014.2330093 (cit. on pp. 3, 5).
[29] L. Laughlin et al. “Optimum Single Antenna Full Duplex Using Hybrid Junctions”. In: Selected Areas in Communications, IEEE Journal on 32.9 (September 2014), pp. 1653-1661. issn: 0733-8716. doi: 10.1109/JSAC.2014. 2330191 (cit. on pp. 2, 3).
[30] R. Askar et al. “Full-Duplex Wireless Transceiver in Presence of I/Q Mismatches: Experimentation and Estimation Algorithm”. In: San Diego, CA, USA: IEEE, 2015, pp. 1-7. isbn: 978-1-4673-9526-7. doi: 10.1109/ GLOCOMW.2015.7413965 (cit. on p. 3).
[31] T. Dinc, A. Chakrabarti, and H. Krishnaswamy. “A 60 GHz same-channel full-duplex CMOS transceiver and link based on reconfigurable polarizationbased antenna cancellation”. In: Radio Frequency Integrated Circuits Symposium (RFIC), 2015 IEEE. May 2015, pp. 31-34. doi: 10.1109/RFIC. 2015.7337697 (cit. on p. 2).
[32] M. Heino et al. “Recent advances in antenna design and interference cancellation algorithms for in-band full duplex relays”. In: Communications Magazine, IEEE 53.5 (May 2015), pp. 91-101. issn: 0163-6804. doi: 10. 1109/MCOM.2015.7105647 (cit. on p. 2).
[33] Y. Hua et al. “Radio self-interference cancellation by transmit beamforming, all-analog cancellation and blind digital tuning”. In: Signal Processing 108 (2015), pp. 322-340. issn: 0165-1684. doi: http://dx.doi.org/10. 1016/j.sigpro.2014.09.025. url: http://www.sciencedirect.com/science/ article/pii/S 0165168414004484 (cit. on p. 4).
[34] L. Laughlin et al. “A Widely Tunable Full Duplex Transceiver Combining Electrical Balance Isolation and Active Analog Cancellation”. In: Vehicular Technology Conference (VTC Spring), 2015 IEEE 81st. May 2015, pp. 1-5. doi: 10.1109/VTCSpring.2015.7145660 (cit. on pp. 2, 3).
[35] L. Laughlin et al. “Electrical balance isolation for flexible duplexing in 5G mobile devices”. In: 2015 IEEE International Conference on Communication Workshop (ICCW). June 2015, pp. 1071-1076. doi: 10.1109/ICCW. 2015.7247319 (cit. on pp. 2, 3).
[36] R. Askar et al. “Agile Full-Duplex Transceiver: The Concept and Self-Interference Channel Characteristics”. In: Oulu, Finland: VDE, 2016, pp. 1-7. isbn: 978-3-8007-4221-9 (cit. on p. 3).
[37] A. C. M. Austin, A. Balatsoukas-Stimming, and A. Burg. “Digital predistortion of power amplifier non-linearities for full-duplex transceivers”. In: 2016 IEEE 17th International Workshop on Signal Processing Advances in Wireless Communications (SPAWC). 2016, pp. 1-5. doi: 10.1109/ SPAWC.2016.7536811 (cit. on p. 5).
[38] J. Liu et al. “Digital Nonlinear Self-Interference Cancellation Based on LMS-Volterra Algorithm”. In: 2016 3rd International Conference on Information Science and Control Engineering (ICISCE). 2016, pp. 1298-1302. doi: 10.1109/ICISCE.2016.277 (cit. on p. 5).
[39] R. Askar et al. “Analysis of utilizing lossless networks for self-interference cancellation purpose”. In: Barcelona, Spain: IEEE, 2018, pp. 1-6. isbn: 978-1-5386-1735-9. doi: 10.1109/WCNC.2018.8377351 (cit. on p. 5).
[40] R. Askar et al. “Decoupling-Based Self-Interference Cancellation in MIMO Full-Duplex Wireless Transceivers”. In: Kansas City, MO, USA: IEEE, 2018, pp. 1-6. isbn: 978-1-5386-4329-7. doi: 10.1109/ICCW.2018.8403640 (cit. on p. 5).
[41] A. Kiayani et al. “Adaptive Nonlinear RF Cancellation for Improved Isolation in Simultaneous Transmit-Receive Systems”. In: IEEE Transactions on Microwave Theory and Techniques 66.5 (2018), pp. 2299-2312. doi: 10.1109/TMTT.2017.2786729 (cit. on p. 5).
[42] D. Korpi et al. “Modeling and Cancellation of Self-Interference in Full-Duplex Radio Transceivers: Volterra Series-Based Approach”. In: 2018 IEEE International Conference on Communications Workshops (ICC Workshops). 2018, pp. 1-6. doi: 10.1109/ICCW.2018.8403638 (cit. on p. 5).
[43] R. Askar, B. Schubert, and W. Keusgen. “Transceiver and method for reducing a self-interference of a transceiver”. English. U.S. Pat. No. 10,291,384 B2. May 2019 (cit. on p. 3).
[44] R. Askar, W. Keusgen, and T. Haustein. “Full-duplex transceiver apparatus”. English. U.S. pat. req. US 2020/244301 A1. July 2020 (cit. on p. 5).
[45] M. H. Attar et al. “Parallel APSM for Fast and Adaptive Digital SIC in Full-Duplex Transceivers with Nonlinearity”. In: 2022 IEEE 23rd International Workshop on Signal Processing Advances in Wireless Communication (SPAWC). IEEE, July 2022. doi: 10.1109/spawc51304.2022.9833961 (cit. on p. 5).
[46] M. H. Attar et al. “Towards Adaptive Digital Self-Interference Cancellation in Full-Duplex Wireless Transceivers: APSM vs. Neural Networks”. In: 2022 56th Asilomar Conference on Signals, Systems, and Computers. IEEE, October 2022. doi: 10.1109/ieeeconf56349.2022.10052049 (cit. on p. 5).
[47] R. Askar and W. Keusgen. “Lossless Decoupling Networks for RF Self-Interference Cancellation in MIMO Full-Duplex Transceivers”. In: IEEE Journal on Selected Areas in Communications 41.9 (September 2023), pp. 2765-2779. issn: 1558-0008. doi: 10.1109/jsac.2023.3287544 (cit. on p. 5).

1. A network entity for a wireless communication network, the network entity comprising:
a plurality of antennas or an antenna array comprising a plurality of antenna elements,
wherein the network entity is configured to control the plurality of antennas or the antenna array to form a plurality of beams and to concurrently transmit and receive on the plurality of beams, the plurality of beams comprising at least a first beam and a second beam,
wherein the network entity is a first network entity configured to communicate with one or more second network entities of the wireless communication network, and
wherein the network entity is configured to sense a surrounding of the network entity using a reflection of a radio signal,
wherein the network entity is configured to transmit the radio signal on the first beam which is directed into a first direction,
wherein the network entity is configured to direct the second beam into a second direction, the second direction pointing towards a reflector, the reflector receiving from the surrounding the reflection of the radio signal and directing the reflection of the radio signal towards the network entity, and
wherein the first direction into which the first beam is directed is different from the second direction into which the second beam is directed.

2. The network entity of claim 1, wherein the radio signal comprises one or more communication specific signals and/or one or more sensing specific signals

3. The network entity of claim 2, wherein the communication specific signals are associated with a communication between the network entity, and the sensing specific signals are not associated with a communication between the network entity but are used only for sensing the surrounding of the network entity.

4. The network entity of claim 2, wherein the one or more communication specific signals comprises on or more of the following:
one or more pilot signals, like Frank-Zadoff-Chu, FZC, sequences or Gold sequences,
one or more reference signals, like a Synchronization Signal Block, SSB, a Phase-tracking reference signal PTRS, a Channel state information reference signal CSI-RS, or a Positioning Reference Signal, PRS,
one or more data signals, like payload or control data for the second network entity.

5. The network entity of claim 1, wherein the one or more sensing specific signals comprises on or more of the following:
one or more pilot signals, like Frank-Zadoff-Chu, FZC, sequences or Gold sequences,
one or more reference signals, like a Synchronization Signal Block, SSB, a Phase-tracking reference signal PTRS, a Channel state information reference signal CSI-RS, or a Positioning Reference Signal, PRS,
one or more data signals, like payload or control data for the second network entity.
linear frequency modulation, LFM, signals,
non-linear frequency modulation, NLFM, signals.

6. The network entity of claim 1, wherein the network entity is configured to set the first direction into which the first beam is directed and the second direction into which the second beam is directed such that a self-interference at the network entity does not exceed a certain threshold,

7. The network entity of claim 6,
wherein, for sensing the surrounding of the network entity at a first distance from the network entity, the certain threshold is a first threshold causing the network entity to set the first and second beams such that the first and second directions are spatially separated by a first amount, like a first angle,
wherein, for sensing the surrounding of the network entity at a second distance from the network entity, the certain threshold is a second threshold causing the network entity to set the first and second beams such that that the first and second directions are spatially separated by a second amount, like a second angle, and
wherein
the first threshold is higher than the second threshold,
the first distance is smaller than the second distance,
the first amount is smaller than the second amount.

8. The network entity of claim 1, wherein the network entity is configured to sense the surrounding of the network entity using the reflection of the radio signal received on the second beam, or
wherein the network entity is configured to sense the surrounding of the network entity using the reflection of the radio signal received on the second beam and a reflection of the radio signal received on the first beam.

9. The network entity of claim 1, wherein sensing the surrounding using the reflection of the radio signal comprises one or more of the following:
detecting one or more objects or living beings within the surrounding,
acquiring information about characteristics of the surrounding and/or one or more objects or living beings within the surrounding.

10. The network entity of claim 9, wherein the characteristics of the one or more objects or living beings within the surrounding comprises one or more of the following:
a shape of an object/living being,
a size of an object/living being,
an orientation of an object/living being,
a speed of an object/living being,
a location of an object/living being, e.g., determining a position of an object/living being relative to the network entity or in absolute coordinates
a distance between an object/living being and the network entity,
a relative motion between objects/living beings,
a condition of an object/living, e.g., for determining to what degree a sensed condition corresponds to an expected condition of an object/living, like a human motion rate accuracy describing a closeness of a measured value of a human body movement frequency caused by parts of the e. human body to the true value of the human body movement frequency,
an image of an object/living being, such as an object material type,
a mapping of the one or more objects/living beings, e.g., for an environmental mapping.

11. The network entity of claim 9, wherein the characteristics of the surrounding comprises one or more of the following:
a weather condition in the surrounding, e.g., a precipitation, like rain or snow fall, in the surrounding,
a geographical nature of the surrounding, like a slope, vegetation.

12. The network entity of claim 9, wherein the one or more objects/living beings sensed by the network entity comprise one or more of the following:
the second network entity of the wireless communication network with which the network entity communicates,
a third network entity of the wireless communication network with which the
network entity does not communicate,
an obstacle or a person in the surrounding of the network entity, e.g.,
an obstacle or a person in a trajectory of the network entity, or
an obstacle or a person blocking a communication link with the second network.

13. The network entity of claim 1, wherein the network entity is configured to form the second beam using information about a location of the reflector relative to the network entity, and wherein the network entity is
preconfigured with a position of the reflector in the wireless communication network or with an angle at which the network entity is positioned relative to the reflector, e.g., during an initial access of the network entity to the wireless communication network, and/or
configured to receive from wireless communication network information about the location of the reflector relative to the network entity or about an angle at which the network entity is positioned relative to the reflector.

14. The network entity of claim 1, wherein the network entity is configured to move, and wherein, when the network entity is moving, the network entity is configured to update the second direction such that the second beam keeps pointing towards the reflector.

15. The network entity of claim 14, wherein the network entity is configured to update the second direction using one or more of the following:
the preconfigured position of the reflector in the wireless communication network,
the preconfigured angle at which the network entity is positioned relative to the reflector,
updated information about the location of the reflector relative to the network entity or about the angle at which the network entity is positioned relative to the reflector.

16. The network entity of claim 13, wherein the network entity is configured to receive the information and/or the updated information from one or more of the following:
a control unit associated with the reflector,
a further network entity, e.g., via a configuration message from a base station,
the reflector.

17. The network entity of claim 1, wherein the network entity is configured to form the second beam using a search mechanism allowing the network entity to select the second beam from a codebook of available beams or from a lookup table that stores historical information.

18. The network entity of claim 1, wherein the network entity, e.g., a user device, UE, is served by a third network entity, like a base station, BS, of the wireless communication network, and
wherein the network entity is configured to
send a sensing request to the third network entity,
receive from the third network entity a message comprising the information about the location of the reflector,
form the second beam directed toward the reflector using the information comprised in the message received from the third network entity.

19. A wireless communication network, comprising:
one or more network entities, the network entity comprising:
a plurality of antennas or an antenna array comprising a plurality of antenna elements,
wherein the network entity is configured to control the plurality of antennas or the antenna array to form a plurality of beams and to concurrently transmit and receive on the plurality of beams, the plurality of beams comprising at least a first beam and a second beam,
wherein the network entity is a first network entity configured to communicate with one or more second network entities of the wireless communication network, and
wherein the network entity is configured to sense a surrounding of the network entity using a reflection of a radio signal,
wherein the network entity is configured to transmit the radio signal on the first beam which is directed into a first direction,
wherein the network entity is configured to direct the second beam into a second direction, the second direction pointing towards a reflector, the reflector receiving from the surrounding the reflection of the radio signal and directing the reflection of the radio signal towards the network entity, and
wherein the first direction into which the first beam is directed is different from the second direction into which the second beam is directed, and
one or more reflectors, the reflector receiving from one or more objects a reflection of a radio signal of the network entity and directing the reflection of the radio signal towards the network entity.

20. A method for sensing and communicating in a wireless communication network, the method comprising:
controlling a plurality of antennas or an antenna array of a first network entity to form a plurality of beams and to concurrently transmit and receive on the plurality of beams, the plurality of beams comprising at least a first beam and a second beam,
communicating, by the first network entity, with one or more second network entities of the wireless communication network, and
sensing, by the first network entity, a surrounding of the first network entity using a reflection of a radio signal, wherein the sensing comprises:
transmitting the radio signal on the first beam which is directed into a first direction, and
directing the second beam into a second direction, the second direction pointing towards a reflector, the reflector receiving from the surrounding the reflection of the radio signal and directing the reflection of the radio signal towards the first network entity,
wherein the first direction into which the first beam is directed is different from the second direction into which the second beam is directed.
